(19) United States
(12) Patent Application Publication
(10) Pub. No.: US 2013/0151265 A1
(43) Pub. Date: Jun. 13, 2013

(54) AUTOMATED MEDICAL BILLING SYSTEM FOR RADIATION THERAPIES

(71) Applicants: Michael Kos, Reno, NV (US); Ryan Lee Wexler, Reno, NV (US)

(72) Inventors: Michael Kos, Reno, NV (US); Ryan Lee Wexler, Reno, NV (US)

(21) Appl. No.: 13/313,424

(22) Filed: Dec. 7, 2011

(51) Int. Cl. G06Q 50/22; G06Q 30/04

(52) U.S. Cl. 705/2

(57) ABSTRACT

An integrated radiation therapy charge capture system utilizes DICOM RT plan information for automatically generating medical billing codes. The system suggests billing codes based on analysis of the treatment plan and the work done. Users are allowed to change the codes and are reminded of implicit items that should be billed. Once a course of treatment is approved and initiated, the codes are generated automatically based on patient ID from the exported DICOM plan.

### BACKGROUND OF THE INVENTION

1. Field of the Invention

The present invention relates to medical billing and, more specifically, to automatically generating medical billing codes for radiation therapy utilizing DICOM RT plan information.

2. The Prior Art

Radiation oncology is the treatment of patients, using radiation therapy as the main modality of treatment. Radiation can be given as a curative modality, either alone or in combination with surgery and/or chemotherapy. It may also be used palliatively, to relieve symptoms in patients with incurable cancers.

Radiation therapy (in the USA), radiation oncology, or radiotherapy (in the UK, Canada and Australia), sometimes abbreviated to “XRT”, is the medical use of ionizing radiation as part of cancer treatment to control malignant cells (not to be confused with radiology, the use of radiation in medical imaging and diagnosis). Radiotherapy may be used for curative or adjuvant treatment. It is used as palliative treatment (where cure is not possible and the aim is for local disease control or symptomatic relief) or as therapeutic treatment (where the therapy has survival benefit and it can be curative). Radiotherapy has several applications in non-malignant conditions, such as the treatment of trigeminal neuralgia, severe thyroid eye disease, pterygium, pigmented villonodular synovitis, prevention of keloid scar growth, and prevention of heterotopic ossification. The use of radiotherapy in non-malignant conditions is limited partly by worries about the risk of radiation-induced cancers.

Radiotherapy is used for the treatment of malignant cancer, and may be used as a primary or adjuvant modality. It is also common to combine radiotherapy with surgery, chemotherapy, hormone therapy, Immunotherapy or some mixture of the four. Most common cancer types can be treated with radiotherapy in some way. The precise treatment intent (curative, adjuvant, neoadjuvant, therapeutic, or palliative) will depend on the tumor type, location, and stage, as well as the general health of the patient.

Radiation therapy is commonly applied to the cancerous tumor. The radiation fields may also include the draining lymph nodes if they are clinically or radiologically involved with tumor, or if there is thought to be a risk of subclinical malignant spread. It is necessary to include a margin of normal tissue around the tumor to allow for uncertainties in daily set-up and internal tumor motion. These uncertainties can be caused by internal movement (for example, respiration and bladder filling) and movement of external skin marks relative to the tumor position.

To spare normal tissues (such as skin or organs which radiation must pass through in order to treat the tumor), shaped radiation beams are aimed from several angles of exposure to intersect at the tumor, providing a much larger absorbed dose there than in the surrounding, healthy tissue.

Brachytherapy, in which a radiation source is placed inside or next to the area requiring treatment, is another form of radiation therapy that minimizes exposure to healthy tissue during procedures to treat cancers of the breast, prostate and other organs.

Historically, the three main divisions of radiotherapy are external beam radiotherapy (EBRT or XRT) or teletherapy, brachytherapy or sealed source radiotherapy, and systemic radioisotope therapy or unsealed source radiotherapy. The differences relate to the position of the radiation source; external is outside the body, brachytherapy uses sealed radioactive sources placed precisely in the area under treatment, and systemic radioisotopes are given by infusion or oral ingestion. Brachytherapy can use temporary or permanent placement of radioactive sources. The temporary sources are often placed by a technique called afterloading. In afterloading a hollow tube or applicator is placed surgically in the organ to be treated, and the sources are loaded into the applicator after the applicator is implanted. This minimizes radiation exposure to health care personnel. Particle therapy is a special case of external beam radiotherapy where the particles are protons or heavier ions. Intraoperative radiotherapy or IORT is a special type of radiotherapy that is delivered immediately after surgical removal of the cancer. This method has been employed in breast cancer (TARGeted Introperative radioTherapy or TARGIT), brain tumors and rectal cancers.

Conventional external beam radiotherapy (2DXRT) is delivered via radiation beams using linear accelerator machines. 2DXRT mainly consists of a single or multiple beams of radiation delivered to the patient from several directions: often front or back, and both sides. Conventional refers to the way the treatment is planned or simulated on a specially calibrated diagnostic x-ray machine known as a simulator because it recreates the linear accelerator actions (or sometimes by eye), and to the usually well-established arrangements of the radiation beams to achieve a desired plan. The aim of simulation is to accurately target or localize the volume which is to be treated. This technique is well established and is generally quick and reliable. One worry is that some high-dose treatments may be limited by the radiation toxicity capacity of healthy tissues which lay close to the target tumor volume. An example of this problem is seen in radiation of the prostate gland, where the sensitivity of the adjacent rectum limited the dose which could be safely prescribed using 2DXRT planning to such an extent that tumor control may not be easily achievable. Prior to the invention of the CT, physicians and physicists had limited knowledge about the true radiation dosage delivered to both cancerous and healthy tissue. For this reason, 3-dimensional conformal radiotherapy had become the standard treatment for a number of tumor sites and this requires a CT scan for simulation.

Stereotactic radiation is a specialized type of external beam radiation therapy. It uses focused radiation beams targeting a well-defined tumor using extremely detailed imaging scans. Radiation oncologists perform stereotactic treatments, often with the help of a neurosurgeon for tumors in the brain or spine.

There are currently two types of stereotactic radiation. Stereotactic radiosurgery (SRS) is when doctors use a single or up to 5 stereotactic radiation treatments of the brain or spine. Stereotactic body radiation therapy (SBR7) refers to one or several stereotactic radiation treatments within the body, such as the lungs.

The planning of radiotherapy treatment has been revolutionized by the ability to delineate tumors and adjacent normal structures in three dimensions using specialized CT and/or MRI scanners and planning software. Virtual simulation, the most basic form of planning, allows more accurate placement of radiation beams than is possible using conventional X-rays, where soft-tissue structures are often difficult to assess and normal tissues difficult to protect.

3-Dimensional Conformal Radiotherapy (3DCRT), uses the profile of each radiation beam which is shaped to fit the profile of the target from a beam's eye view (BEV) using a multileaf collimator (MLC) or shaped block and a variable number of beams. When the treatment volume conforms to the shape of the tumor, the relative toxicity of radiation to the surrounding normal tissues is reduced, allowing a higher dose of radiation to be delivered to the tumor than conventional techniques would allow.

Intensity-Modulated Radiation Therapy (IMRT) is an advanced type of high-precision radiation that is the next generation of 3DCRT. IMRT also improves the ability to conform the treatment volume to concave tumor shapes, for example when the tumor is wrapped around a vulnerable structure such as the spinal cord or a major organ or blood vessel. Computer-controlled x-ray accelerators distribute precise radiation doses to malignant tumors or specific areas within the tumor. The pattern of radiation delivery is determined using highly tailored computing applications to perform optimization and treatment simulation (Treatment Planning) The radiation dose is consistent with the 3-D shape of the tumor by controlling, or modulating, the radiation beam's intensity. The radiation dose intensity is elevated near the gross tumor volume while radiation among the neighboring normal tissue is decreased or avoided completely. The customized radiation dose is intended to maximize tumor dose while simultaneously protecting the surrounding normal tissue. This may result in better tumor targeting, lessened side effects, and improved treatment outcomes than even 3DCRT.

3DCRT is still used extensively for many body sites but the use of IMRT is growing in more complicated body sites such as CNS, head and neck, prostate, breast and lung. IMRT is currently limited by its cost and its associated need for additional time from experienced medical personnel. Physicians must manually delineate the tumors on the CT images through the entire disease site. Medical physicists and dosimetrists must be engaged to create a viable treatment plan. IMRT technology has only been used commercially since the late 1990s even at the most advanced cancer centers.

Particle therapy (Proton therapy being one example), uses energetic ionizing particles (protons, electrons or carbon ions) which are directed at the target tumor. In the case of protons, the dose increases suddenly while the particle penetrates the tissue, up to a maximum (the “Bragg peak”) that occurs near the end of the particle's range, and it then drops to (almost) zero. The advantage of this energy deposition profile is that less energy is deposited into the healthy tissue surrounding the target tissue.

Brachytherapy (internal radiotherapy) is delivered by placing radiation source(s) inside or next to the area requiring treatment. Brachytherapy is commonly used as an effective treatment for cervical, prostate, breast, and skin cancer and can also be used to treat tumours in many other body sites. As with stereotactic radiation, brachytherapy treatments are often known by their brand names. For example, brand names for breast cancer brachytherapy treatments include SAVI, MammoSite, and Contura. Brand names for prostate cancer include Proxcelan, TheraSeed, and I-Seed.

In brachytherapy, radiation sources are precisely placed directly at the site of the cancerous tumor. This means that the irradiation only affects a very localized area—exposure to radiation of healthy tissues further away from the sources is reduced. These characteristics of brachytherapy provide advantages over external beam radiotherapy—the tumor can be treated with very high doses of localized radiation, whilst reducing the probability of unnecessary damage to surrounding healthy tissues. A course of brachytherapy can often be completed in less time than other radiotherapy techniques. This can help reduce the chance of surviving cancer cells dividing and growing in the intervals between each radiotherapy dose.

DICOM (Digital Imaging and Communications in Medicine) is a standard for handling, storing, printing, and transmitting information in medical imaging. It includes a file format definition and a network communications protocol. The communication protocol is an application protocol that uses TCP/IP to communicate between systems. DICOM files can be exchanged between two entities that are capable of receiving image and patient data in DICOM format. The National Electrical Manufacturers Association (NEMA) holds the copyright to this standard. It was developed by the DICOM Standards Committee, whose members are also partly members of NEMA. DICOM is known as NEMA standard PS3, and as ISO standard 12052:2006 “Health informatics—Digital imaging and communication in medicine (DICOM) including workflow and data management”.

DICOM enables the integration of scanners, servers, workstations, printers, and network hardware from multiple manufacturers into a picture archiving and communication system (PACS). The different devices come with DICOM conformance statements which clearly state the DICOM classes they support. DICOM has been widely adopted by hospitals and is making inroads in smaller applications like dentists' and doctors' offices.

DICOM differs from some, but not all, data formats in that it groups information into data sets. That means that a file of a chest X-Ray image, for example, actually contains the patient ID within the file, so that the image can never be separated from this information by mistake. This is similar to the way that image formats such as JPEG can also have embedded tags to identify and otherwise describe the image.

A DICOM data object consists of a number of attributes, including items such as name, ID, etc., and also one special attribute containing the image pixel data (i.e. logically, the main object has no “header” as such: merely a list of attributes, including the pixel data). A single DICOM object can only contain one attribute containing pixel data. For many modalities, this corresponds to a single image. But note that the attribute may contain multiple “frames”, allowing storage of cine loops or other multi-frame data. Another example is NM data, where an NM image, by definition, is a multi-dimensional multi-frame image. In these cases three- or four-dimensional data can be encapsulated in a single DICOM object. Pixel data can be compressed using a variety of standards, including JPEG, JPEG Lossless, JPEG 2000, and Run-length encoding (RLE). LZW (zip) compression can be used for the whole data set.

DICOM RT is the popular name for the extension of the DICOM 3.0 standard which handles the Radiotherapy modality. It was developed to extend the current DICOM 3.0 standard to include the RT modality, rather than produce a completely new standard. Five objects define the RT modality:
RT Image—Scope includes all the normal RT images, DRRs, portal images, simulator images and radiographs;
RT Dose—Scope is the total dose distributions from the planning system; dose matrix, dose points, isodose curves and dose volume histograms.
RT Structure Set—Scope is the patient related structures identified from diagnostic data, CT, virtual simulation and treatment planning system.
RT Plan—Scope is the geometric and dosimetric data for course of external beam treatment or brachytherapy.
RT Treatment Record—Scope is to record all the treatment session data.

Medical billing & Coding is the process of submitting and following up on claims to insurance companies in order to receive payment for services rendered by a healthcare provider. The same process is used for most insurance companies, whether they are private companies or government-owned.

The medical billing process is an interaction between a health care provider and the insurance company and or the patient (payer). The entirety of this interaction is known as the billing cycle. This can take anywhere from several days to several months to complete, and require several interactions before a resolution is reached. The interaction begins with the office visit: a doctor or their staff will typically create or update the patient's medical record. This record contains a summary of treatment and demographic information including, but not limited to, the patient's name, address, social security number, home telephone number, work telephone number and their insurance policy identity number. If the patient is a minor then guarantor information of a parent or an adult related to the patient will be appended. Upon the first visit, the provider will usually give the patient one or more diagnoses in order to better coordinate and streamline their care. In the absence of a definitive diagnosis, the reason for the visit will be cited for the purpose of claims filing. The patient record contains highly personal information, including the nature of the illness, examination details, medication lists, diagnoses, and suggested treatment.

The extent of the physical examination, the complexity of the medical decision making and the background information (history) obtained from the patient are evaluated to determine the correct level of service that will be used to bill. The level of service, once determined by qualified staff is translated into a standardized five digit procedure code drawn from the Current Procedural Terminology database. The verbal diagnosis is translated into a numerical code as well, drawn from a similar standardized ICD-9-CM code. These two codes, a CPT and an ICD-9-CM (will be replaced by ICD-10-CM as of Oct. 1, 2013) are both important for claims processing.

Once the procedure and diagnosis codes are determined for a medical claim, the medical biller will typically transmit the claim to the insurance company (payer). This is usually done electronically by formatting the claim as an ANSI 837 file and using Electronic Data Interchange to submit the claim file to the payer directly or via a clearinghouse. Historically however, claims were submitted using a paper form; in the case of professional (non-hospital) services and for most payers the CMS-1500 form was and is still commonly used. The CMS-1500 form is so named for its originator, the Centers for Medicare and Medicaid Services. Currently, about 30% of medical claims get sent to payers using paper forms which are either manually entered or entered using automated recognition or OCR software.

The insurance company (payer) processes the claims usually by medical claims examiners or medical claims adjusters. Approved claims are reimbursed, typically for a certain percentage of the billed services. Failed claims are rejected and notice is sent to the provider. All claim information is returned to providers in the form of Explanation of Benefits (EOB) or Remittance Advice.

Upon receiving a rejection message the provider must decipher the message, reconcile it with the original claim, make required corrections and resubmit the claim or provide additional information. This exchange of claims and rejections may be repeated multiple times until a claim is paid in full according to a contract or otherwise, or the provider relents and accepts an incomplete reimbursement. The frequency of rejections, denials, and over payments can be high, mainly because of the high complexity of claims and/or errors due to similarities in diagnosis' and their corresponding codes.

A problem with billing in radiation oncology is that the treatments are often very complex, and that can result in high error rates. Compounding this, this area of medicine is one of the most costly, due to the high cost of the equipment and highly trained staff being utilized. It would thus be advantageous if radiation oncology treatment could be accurately and efficiently billed.

### BRIEF SUMMARY OF THE INVENTION

This patent discloses and claims a useful, novel, and unobvious invention for an automatic generator of billing codes for radiation therapy in the medical billing field.

An integrated radiation therapy charge capture system utilizes DICOM RT plan information for automatically generating medical billing codes. The system suggests billing codes based on analysis of the treatment plan and the work done. Users are allowed to change the codes and are reminded of implicit items that should be billed. Once a course of treatment is approved and initiated, the codes are generated automatically based on patient ID from the exported DICOM plan.

### BRIEF DESCRIPTION OF THE DRAWINGS

FIG. 1 is a diagram illustrating exemplary computer controlled radiation therapy;

FIG. 2 is a flowchart illustrating major software components, in accordance with one embodiment of the present invention;

FIG. 3 is a flowchart illustrating DICOM Code Interpreter and Billing System

Integration Workflow, in accordance with one embodiment of the present invention;

FIG. 4 is a block diagram illustrating components of one embodiment of the present invention;

FIG. 5 is a drawing showing a Patient Demographics window of a Patient Chart, in accordance with one embodiment of the present invention;

FIG. 6 is a drawing showing a Treatment Courses window of a Patient Chart, in accordance with the example shown in FIG. 5;

FIG. 7 is a drawing showing a Practice Management window, in accordance with the example shown in FIGS. 5 and 6;

FIGS. 8 and 9 are drawings illustrating examples of medical images stored in DICOM format for use by a physician in treating patients;

FIGS. 10 and 11 are drawings illustrating examples of visual representations of treatment plans;

FIG. 12 is a drawing showing a processing queue window, in accordance with one embodiment of the present invention and the example shown in FIGS. 5-7;

FIG. 13 is a drawing showing an Assign Plan to Treatment Course window, in accordance with the embodiment and example shown in FIG. 12;

FIGS. 14-16 are drawings showing an Edit Plan window, in accordance with the embodiment and example shown in FIGS. 12-13;

FIG. 17 is a drawing showing an Edit Immobilization Device pop-up window overlaid over the inactive Edit Plan window shown in FIGS. 14-16;

FIG. 18 is a drawing showing the Edit Plan window shown in FIG. 16, after the immobilization device was selected in FIG. 17;

FIGS. 19 and 20 are drawings showing a billing Code Capture window, in accordance with one embodiment of the present invention and the example given in FIGS. 12-18;

FIG. 21 is a drawing showing an Add Code window above an inactive billing Code Capture window shown in FIG. 20;

FIG. 22 is a drawing showing the billing Code Capture window shown in FIGS. 19 and 20 after the code from the Add Code menu shown in FIG. 21 has been accepted;

FIG. 23 is a drawing showing a Practice Management window, in accordance with the embodiment and example shown in FIG. 7, showing the codes from FIG. 22 captured;

FIG. 24 is a drawing showing an example of treatment apparatus being used to apply treatment to a patient;

FIG. 25 is a drawing showing a Find Plan popup window, in accordance with the embodiment and example shown in FIGS. 5-23;

FIG. 26 is a drawing showing an Add Code window, in accordance with the embodiment and example shown in FIGS. 5-25;

FIG. 27 is a drawing showing an inactive Treatment Courses window overlaid over an inactive Treatment Plan window, in accordance with the embodiment and example shown in FIG. 6;

FIG. 28 is a drawing showing an active Treatments window overlaid over an inactive Edit Plan window, as shown in FIGS. 14-18;

FIG. 29 is a drawing showing a Treatment Attribute window, in accordance with the embodiment and example show in FIGS. 5-28;

FIG. 30 shows a Capture Code window, in accordance with the embodiment and example shown in FIGS. 5-28;

FIG. 31 is a drawing showing an exemplary Health Insurance Claim Form, in accordance with one embodiment of the present invention;

FIG. 32 is a drawing showing a Code Capture window, in accordance with the embodiment and example shown in FIGS. 5-30; and

FIG. 33 is a block diagram illustrating a General Purpose Computer, such as are shown as computers and servers in FIG. 4.

### DETAILED DESCRIPTION

There is an unmistakable opportunity for improving Radiation Therapy Charge capture. The current methods are redundant, yield inaccurate results and require unnecessary training Much of charge capture is performed manually. This is laborious, labor intensive, and error prone. Understanding which codes go with which procedures takes significant training Currently available software has attempted to simplify this process. Codes are abstracted with more intuitive internal names. Concepts like schedule based billing are used to try and automate the process. Also, the many different types of radiation therapy planning and treatment delivery are generalized.

While this simplification has made billing manageable, it is a flawed methodology. Radiation therapy billing is not simple. It is based off of a very complicated scoring algorithm with a great many factors involved. Additionally, the number of code bundling options and mutually exclusive codes is very large relative to the total number of billing codes. These factors make becoming an expert in RT billing very difficult.

Radiation Therapy is a unique specialty because of the very close relationship and interaction between the planning, simulation, and treatment of patients and the planning computer systems and treatment machines. For one thing, nearly every step during the course of treatment detailed data is collected or recorded about the planning and treatment and stored in computer planning systems. This data encompasses the factors needed to perform charge capture.

The next step in radiation therapy billing is not abstracting the billing codes or coming up with better training methods. It is rather to simply use the data already available, the data that the techs, dosimetrist, physician, and physicist themselves had a hand in generating, and to transform that data into billing codes.

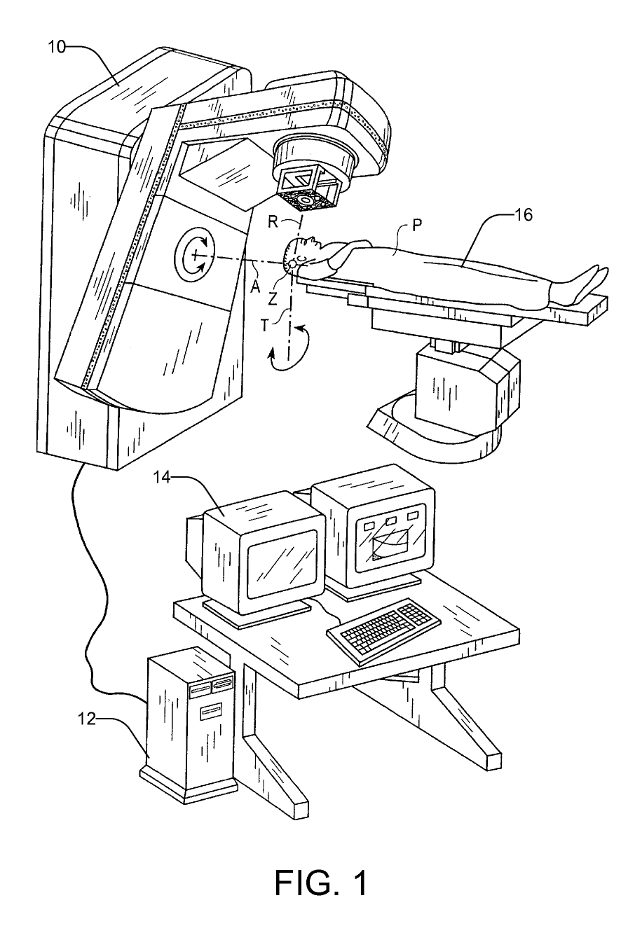

FIG. 1 is a diagram illustrating exemplary computer controlled radiation therapy. Radiation treatment apparatus 10 is computer controlled 12. Also connected to the computer 12 are monitor 14 and keyboard, usable for precisely controlling the operation of the radiation treatment apparatus 10. Also shown is a patient 16, under treatment by the radiation treatment apparatus 10.

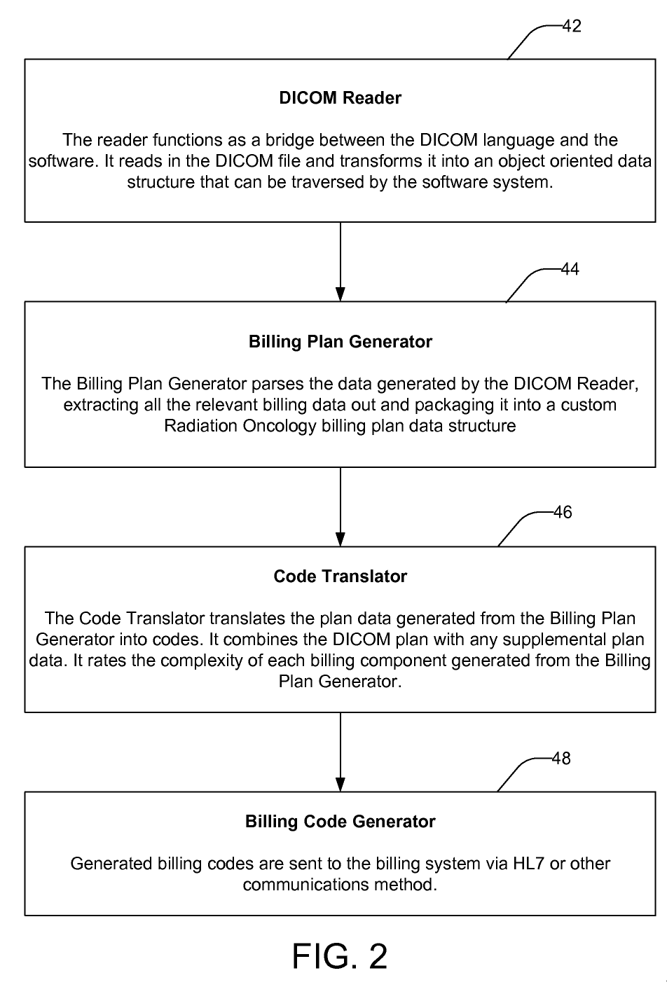

FIG. 2 is a flowchart illustrating major software components, in accordance with one embodiment of the present invention. A DICOM Reader 42 functions as a bridge between the DICOM language and the software exhibiting the present invention. The reader's 42 function is primarily to read the DICOM files and transform them into an object oriented data structure that is traversable by that software.

A Billing Plan Generator 44 parses the data produced by the DICOM reader 42, extracting all of the relevant billing data and packaging it into a custom Radiation Oncology billing plan data structure. The Billing Plan Generator 44 converts each data component into scorable billing components. Next, it compiles all of the components into an orderly package that only contains those billing components. Some examples of these components are: the number of beams; the changing gantry angles of beams; and the number of Multi-Leaf Collimation (MLC) blocking positions. However, this is simplified for descriptive purposes. These components are often utilized in combination and viewed as composite components. For instance, the count of MLC positions, variations of the MLC positions, and the gantry angle may be combined to represent a single variable component. Treatment device information is also pulled in one embodiment of the present invention. Typically, all of the diagnostic information is utilized as well. All of the variations and combinations of these components relate to the billing codes that can be generated and the complexity of the codes.

A Code Translator 46 represents the final step in the process. The Code Translator 46 translates the plan data generated from the Billing Plan Generator 44 into billing codes. It combines the DICOM plan with any supplemental plan data. The Code Translator 46 rates the complexity of each billing component generated from the Billing Plan Generator 44. Depending on the phase of treatment and where the process is in the workflow, it may generate 5 different categories of billing codes in the present embodiment:
A) Treatment Planning Codes
B) Simulation Codes
C) Isodose Planning Codes
D) Treatment Device Charges
E) Treatment Delivery Codes.

A Billing Code Generator 48 then generates the actual billing codes that are sent to the billing system via HL7 or utilizing another communications method or system.

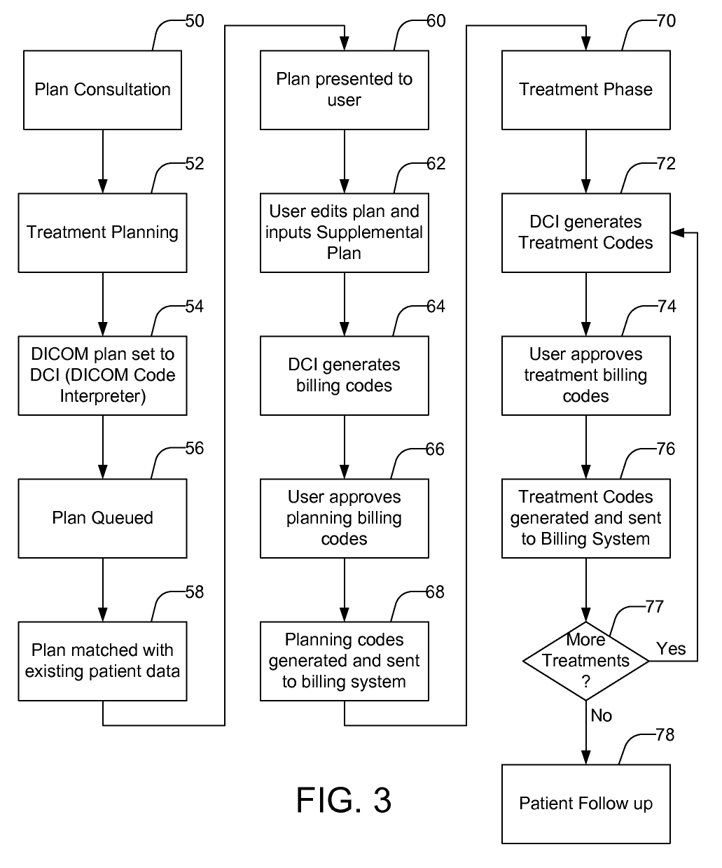

FIG. 3 is a flowchart illustrating DICOM Code Interpreter and Billing System Integration Workflow, in accordance with one embodiment of the present invention. The workflow starts with a Patient Consultation, step 50. This is similar to how most physicians operate, and is recorded separately. Next comes Treatment Planning, step 52. Data is recorded into the treatment planning system in DICOM format. The DICOM plan is then sent to the DICOM Code Interpreter (DCI), step 54. The DCI functions as a DICOM SCP (Service Class Provider) and the treatment planning system as an SCU (Service Class User). The DICOM Plan is recorded in a queue, step 56, and awaits user interaction before the code generation process begins. The DICOM Plan is then matched with existing patient data, step 58. The patient is preferably and typically automatically matched with existing clinical data in the system using the patient identifiers built-into the DICOM standards. If no match is found, the DICOM Plan is manually associated with patient data.

The treatment plan is then presented to the system user, step 60. Technical DICOM data is displayed in human readable form via the DICOM Plan Generator component of the DCI. The user then can edit Plan and may input a Supplemental Plan, step 62. Technical data components, such as the number of beams and blocks, can be modified. Additionally, supplemental plan data, which is plan data that was not included in the DICOM plan, can be added at this point. This may include clinical factors or information on other simultaneous treatment for the same diagnosis that might affect the complexity of the plan.

The DCI then generates billing codes, step 64. The DICOM and supplemental plan data are saved and then input into the DCI. The DCI process the data and generates the planning billing codes. The user then approves the planning billing codes, step 66. The user is presented with recommended billing codes, and can adjust them if necessary.

The treatment phase of the workflow then commences, step 70. Every time a treatment occurs, the DICOM treatment data for that treatment is relayed to the DCI. The patient is automatically identified with the previously linked DICOM identifiers. The DICOM treatment data is associated with the previously recorded DICOM plan and supplemental data. The DCI generates treatment codes, step 72. The DCI leverages the old plan data recorded along with the new data in order to generate treatment codes. The user approves those treatment billing codes, step 74. The approved billing codes are again sent directly to the billing system or sent via HL7. They are recorded in the patient's account and are ready to be invoiced. This cycle, starting with the treatments, step 70, repeats until the treatment regime is complete. At that point, the Follow Up phase commences, step 78. This phase is again more similar to that practiced by most physicians, and is recorded and billed separately.

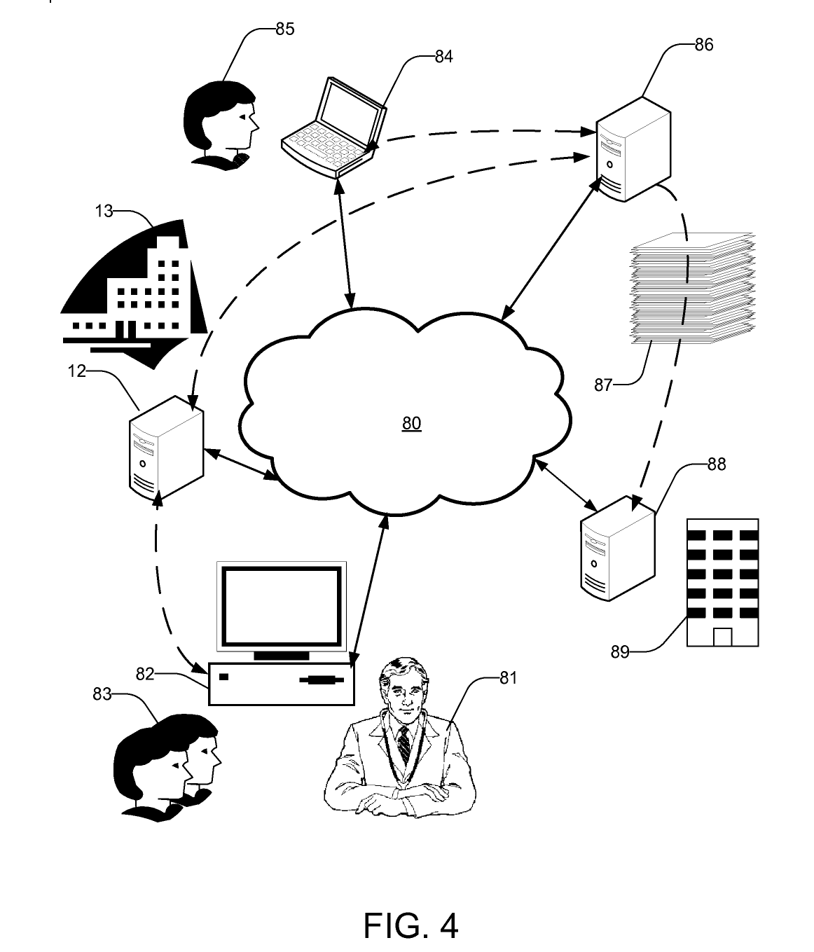

FIG. 4 is a block diagram illustrating components of one embodiment of the present invention. A number of computers 12, 82, 84, 86, 88 are connected utilizing one or more networks 80. One computer system 12, typically located at a medical facility such as a hospital 13, is utilized to execute a treatment plan controlling the operation of the treatment machines 10 (see FIG. 1). A physician 81 utilizes a computer system 82 to develop a treatment plan. A user 85, who may be a billing specialist, or the physician himself, reviews the billing codes, making changes as required. A billing code generation system 86 then generates bills 87 that are transmitted to a payer system 88, at, for example, an insurance company 89, or government agency such as Medicare.

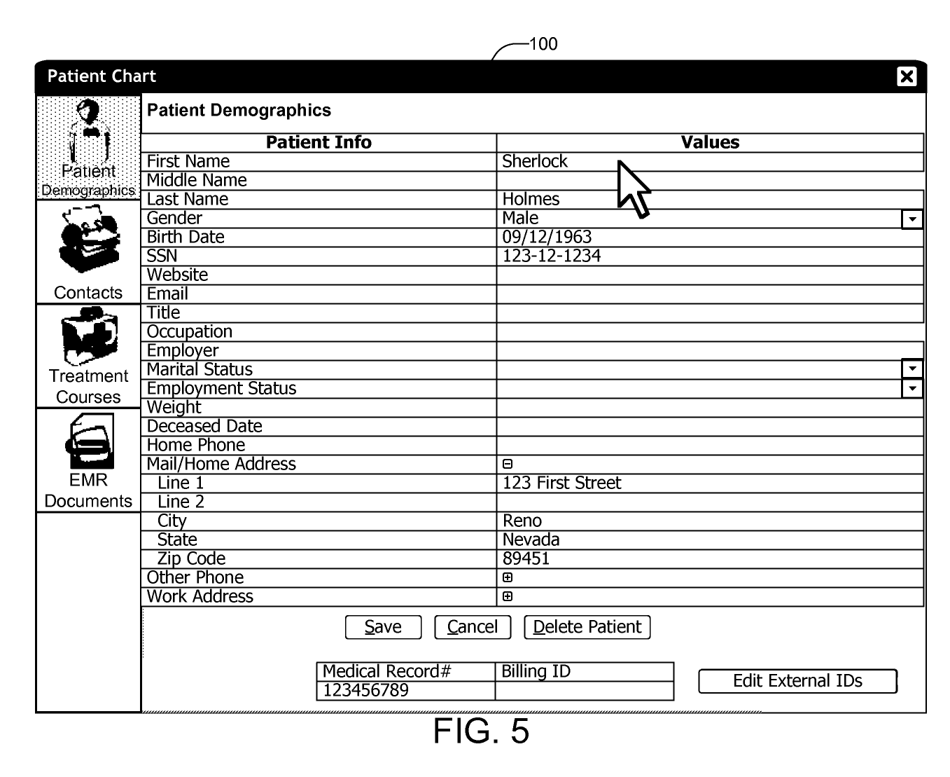

FIG. 5 is a drawing showing a Patient Demographics window 100 of a Patient Chart, in accordance with one embodiment of the present invention. The first step of patient treatment is the initial patient consultation. This is one of the only parts of the treatment that is somewhat detached from the planning software and treatment machines. After the patient meets with the physician the patient data is recorded in the system. Here are the patient demographics for our new exemplary patient, “Sherlock Homes”.

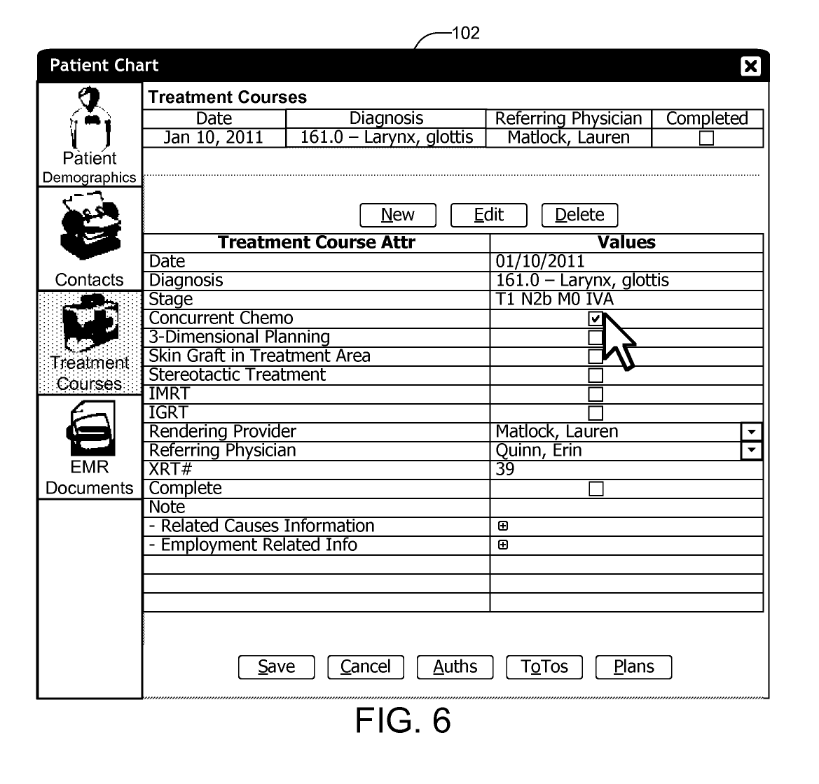

FIG. 6 is a drawing showing a Treatment Courses window 102 of a Patient Chart, in accordance with the example shown in FIG. 5. In this example, patient Sherlock Holmes is being treated for a head and neck cancer. Because patient “Sherlock Holmes” is undergoing concurrent chemo therapy, it is notated in the software. This is shown by the check box by the cursor.

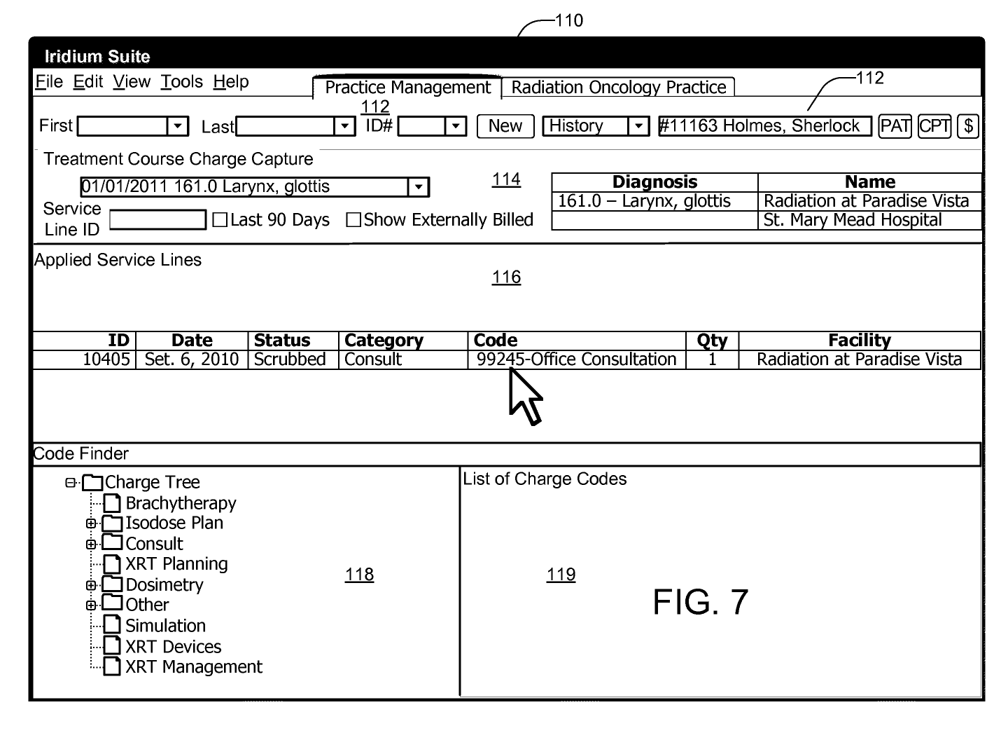

FIG. 7 is a drawing showing a Practice Management window 110, in accordance with the example shown in FIGS. 5 and 6. At this point an initial 99245 complex consultation charge has been captured. In the top section of the window 112, pull down boxes are provided for searching for a patient by his name or ID#. In this case, patient #11163, Sherlock Holmes, has been identified. The next section 114, titled “Treatment Course Charge Capture” 114, includes boxes for the “Diagnosis”, as well as treatment facilities. The third section 116 is titled “Applied Service Lines”, and this section is where the consultation charges are captured. For each charge, an ID, Date, Status, Category, Code, Quantity (Qty), and Facility are displayed. The bottom of the window is split between a Code Finder 118 and a List of Charge Codes 119. The Code Finder 118 is tree structured, allowing for easy identification and selection of charge codes.

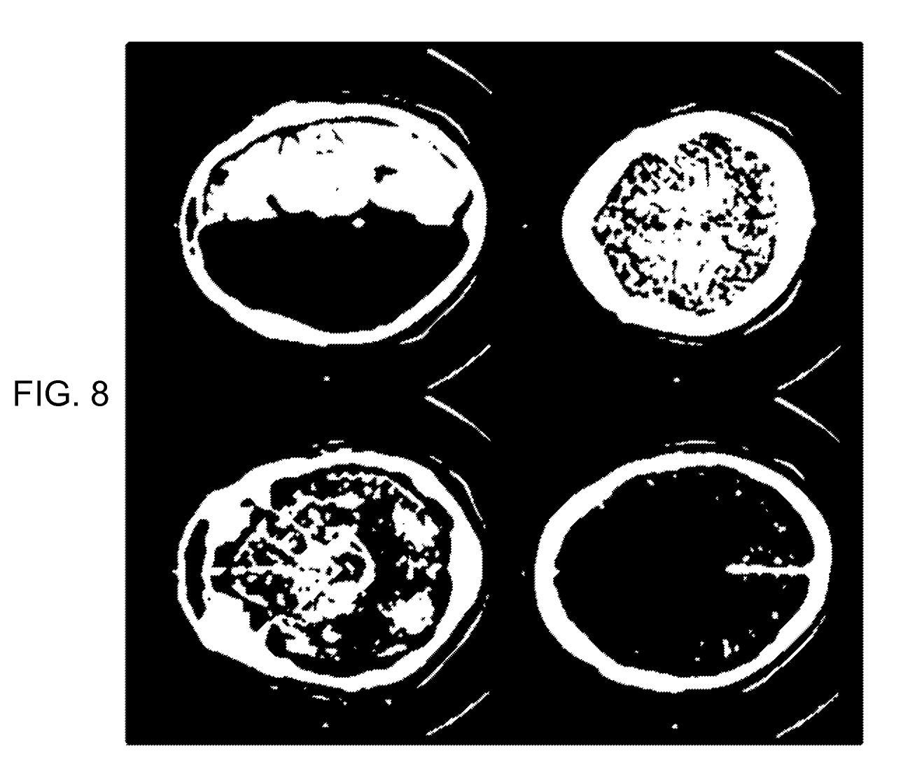

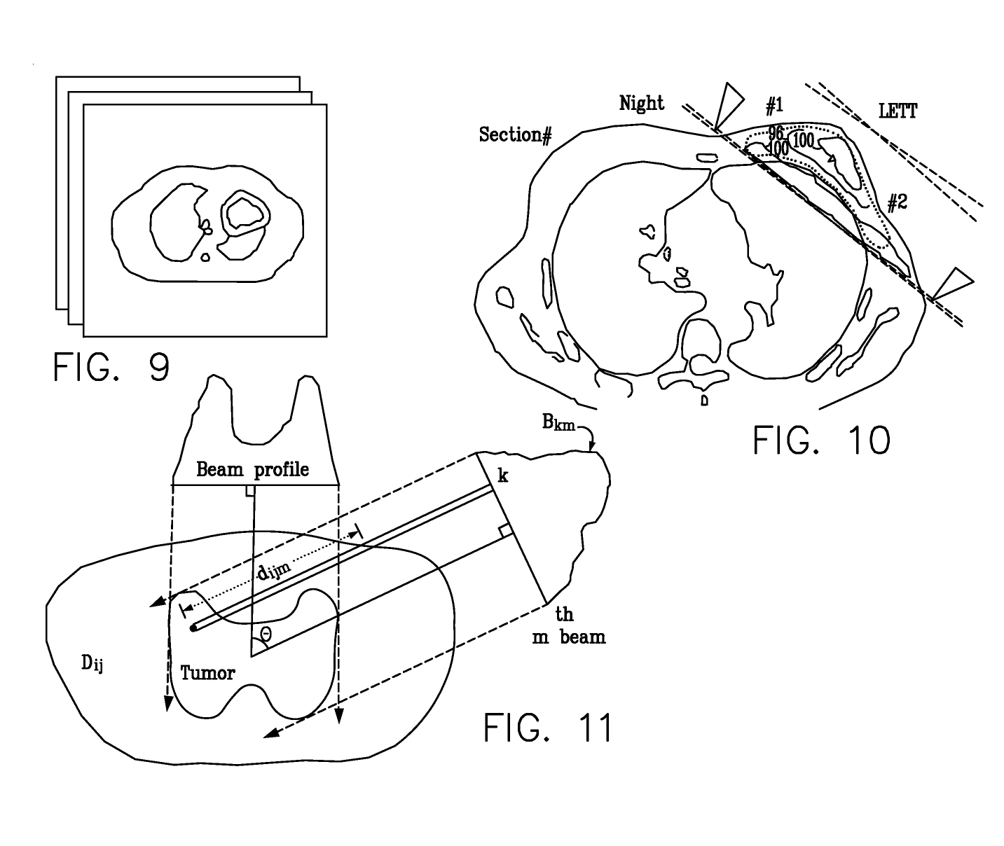

FIGS. 8 and 9 are drawings illustrating examples of medical images stored in DICOM format for use by a physician in treating patients. These FIGs. show different modalities. FIG. 8 is a brain scan, while FIG. 9 shows a series of cross sections of a torso. These are exemplary, and other modalities are within the scope of the present invention.

FIGS. 10 and 11 are drawings illustrating examples of visual representations of treatment plans. Much of the treatment provided by radiation oncologists is computer controlled. A treatment Plan is developed that precisely identifies what beams and other modalities are to be utilized and applied, when and where, at what angles and intensities, etc. The Plan is typically checked, rechecked, and simulated. In the preferred embodiment of the present invention, the treatment plan is transmitted between systems utilizing DICOM RT.

After the consultation the planning phase commences. A simulation must be completed. Patient positioning is determined, and immobilization devices are created and then CT (and/or other modality) scans are taken. The physician determines the location and amount of radiation and the necessary blocking All this data is precisely entered into a treatment planning system.

The data is stored in the ACR/NEMA RT DICOM standard. The DICOM standard accurately stores and portrays all this data and the accompanying images. Today the DICOM standard is recognized by virtually all imaging devices. DICOM standard is gaining even further momentum today in Radiation Therapy as the method to store RT images, the plan, the treatment record and generally all attributes related to the planning and delivery process.

The DICOM data can be used as the primary source of information to generate billing codes. Once the plan is complete, the planning system can send the plan to the software implementing the present invention using the standard DICOM communication protocol. The planning system will act as the DICOM service class user and the software will act as the service class provider.

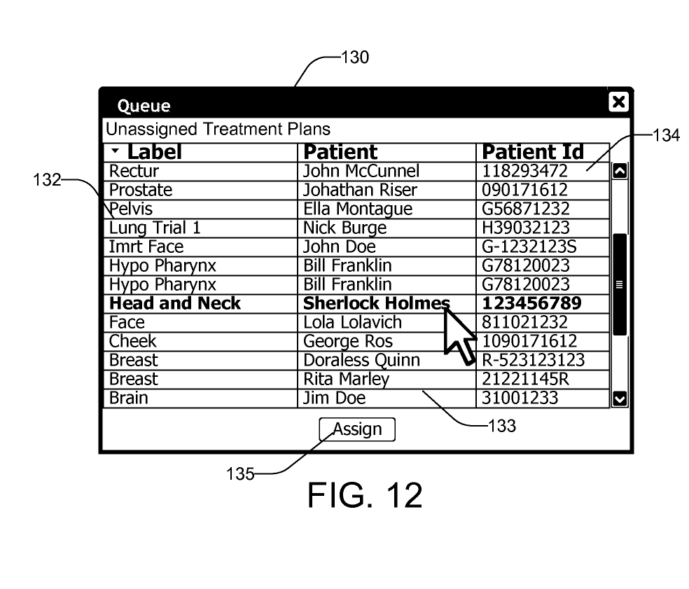

FIG. 12 is a drawing showing a processing queue window 130, in accordance with one embodiment of the present invention and the example shown in FIGS. 5-7. The software system stores the incoming plans in a queue awaiting processing. The plans must be assigned to the appropriate patient in the system. This process is automated if the patient identifier in the DICOM system can be matched to the one in the system. This Plan highlighted is for patient “Sherlock Holmes”. The Processing Queue window 130 has three columns: Label 132, Patient 133, and Patient ID 134. An “Assign” button 135 on the bottom of the window can be clicked to assign the treatment plan to the patient.

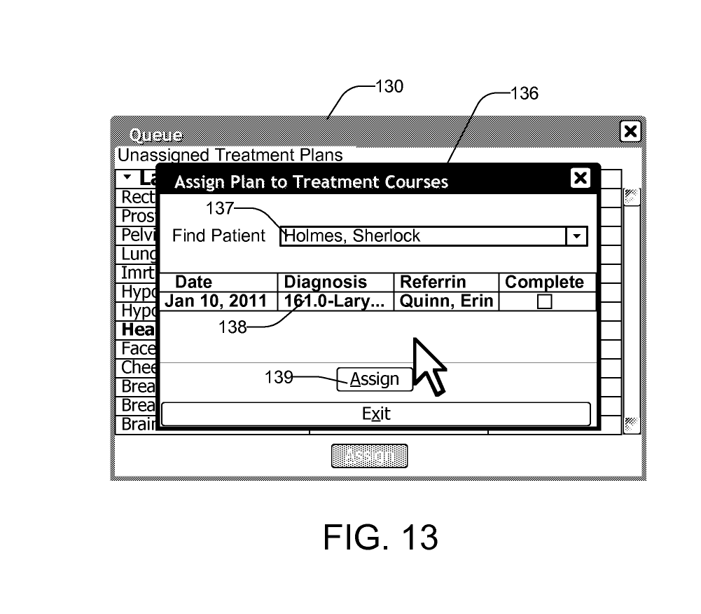

FIG. 13 is a drawing showing an Assign Plan to Treatment Course window 136, in accordance with the embodiment and example shown in FIG. 12 for exemplary patient “Sherlock Holmes”. At the top of the window is a pull down box that displays the patient name 137. Below this is identifying information 138 for the plan. After the correct patient has been identified, the plan is assigned to the appropriate patient's treatment course when an “Assign” button is clicked. Then it is displayed for editing and processing.

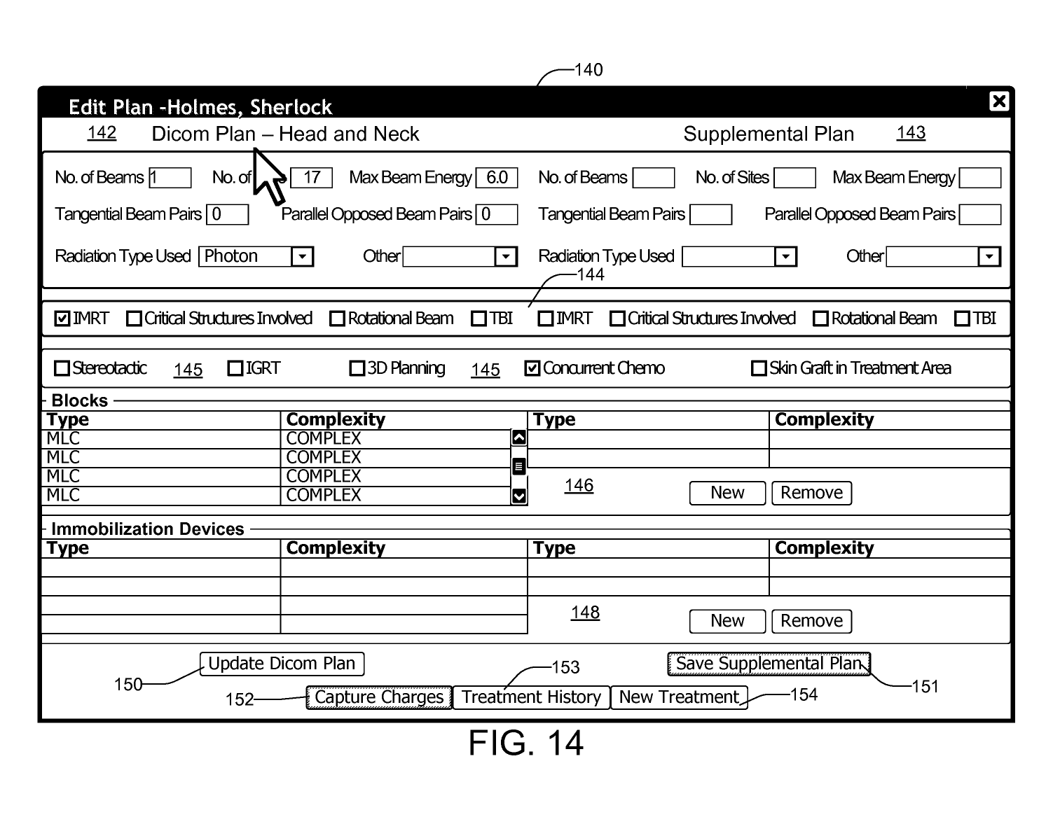

FIG. 14 is a drawing showing an Edit Plan window 140, in accordance with the embodiment and example shown in FIGS. 12-13 for exemplary patient “Sherlock Holmes”. The Plan for the patient is displayed for editing and processing. On the left is shown a summary of the data generated from the DICOM plan 142. The right side shows a summary of the Supplemental Plan 143, which will be discussed in later FIGs. Only the core data is shown for verification in this embodiment, but it is all stored in the system and used for charge capture. In this example, it is shown that there were 17 beams of Photon radiation delivered to a single site with a max energy of 6. It is determined from the DICOM data that this head and neck plan is an Intensity-Modulated Radiation Therapy (IMRT) plan. There are 16 MLC sequences and so each is represented as a separate complex block.

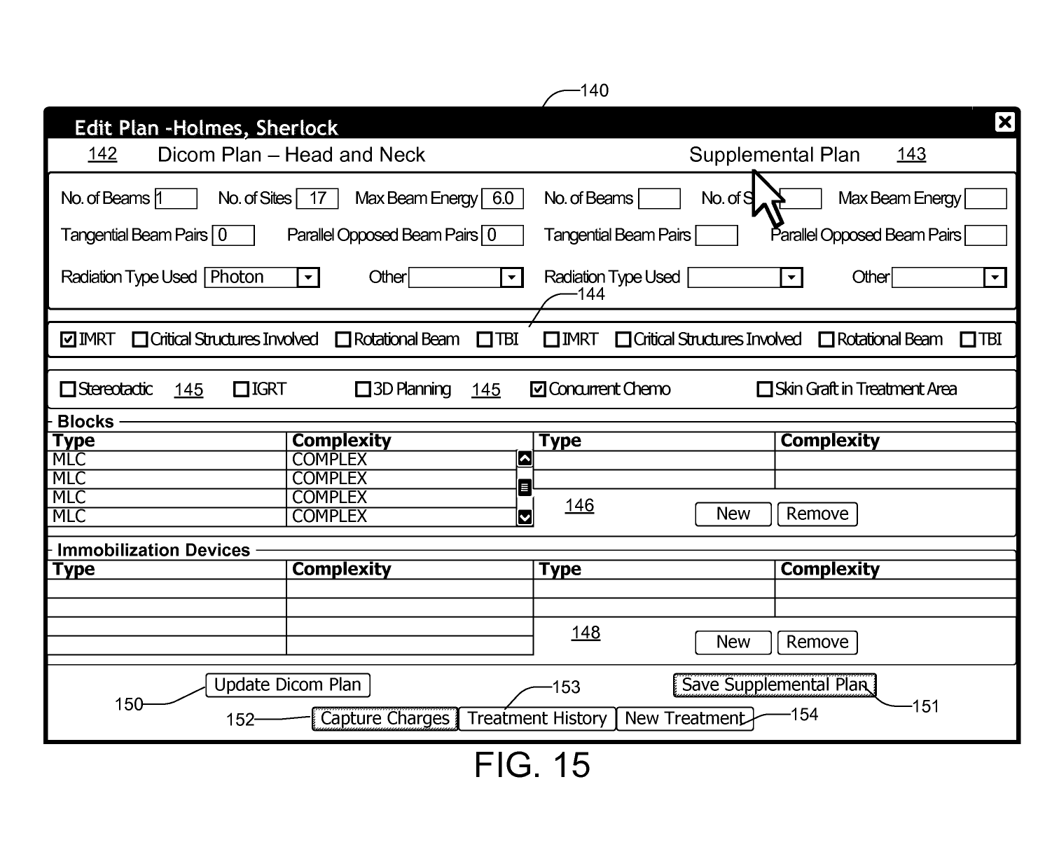

FIG. 15 is a drawing showing the Edit Plan window 140 shown in FIG. 14, with concentration on the Supplemental Plan 143. On the right is displayed the Supplemental Plan 143. The supplemental plan is used to manually fill in any holes in treatment and/or billing that the DICOM Plan left out. The data from both plans are used together to generate codes. If a plan is complete, almost no manual entry should be required. As indicated above, in this example, Sherlock Holmes is undergoing concurrent chemo. This is automatically marked in the plan.

In these Edit Plan windows 140, the name of the patient is listed on the top of the window. Below that, the top portion of the window is split between the DICOM Plan 142 and the Supplemental Plan 143. There is then a section for additional information 144, such as that IMRT is involved in this treatment. Other additional information is entered in the next section 145, such as that the patient is undergoing concurrent chemotherapy. Below these sections is a section that shows the Blocks required 146, and then one for Immobilization Devices 148. Both of these sections are split between the DICOM Plan 142 on the left and the Supplemental Plan 143 on the right. Below these sections are command buttons for updating the DICOM Plan 150 and the Supplemental Plan 151, as needed. At the bottom of the window are “Capture Charges” 152, “Treatment History” 153, and “New Treatment” 154 buttons.

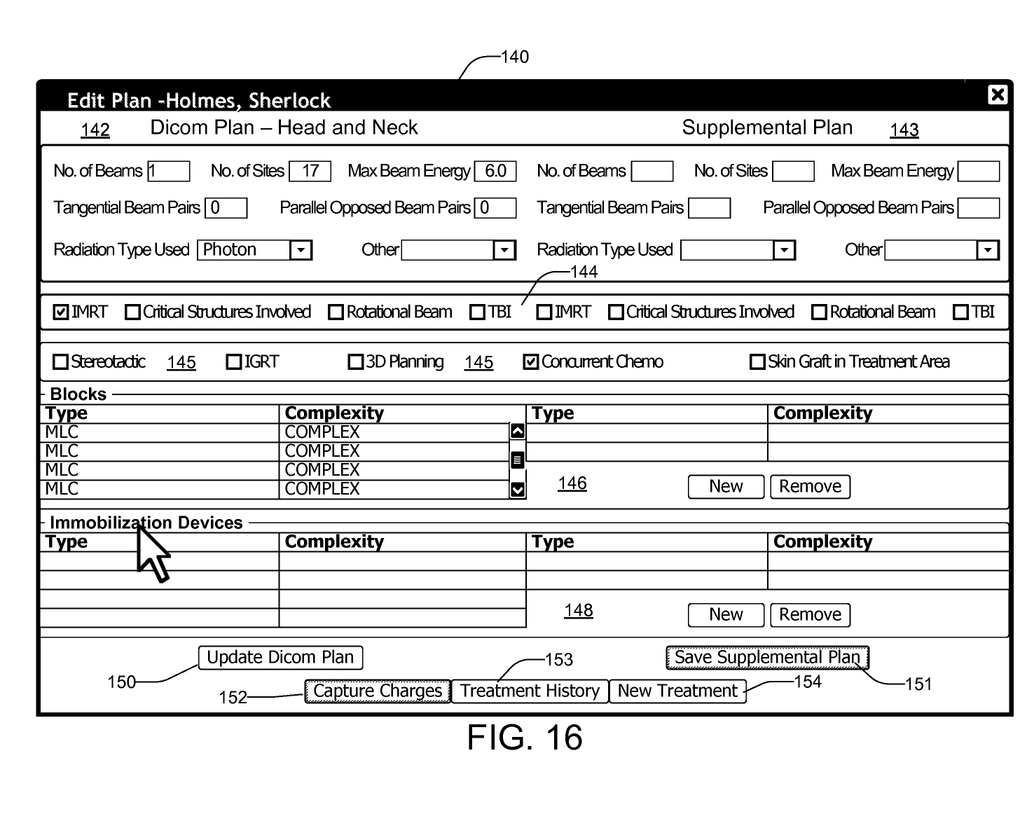

FIG. 16 is a drawing showing the Edit Plan window 140 shown in FIGS. 14 and 15, with concentration on the Immobilization Devices 148. An immobilization device is a device that is used to help a patient remain in the same position during every treatment. The system generates either red or green lines around the boxes and sections of this window to indicate whether there is data for the section or box, or not. Red indicates that there is no data for this area from either the auto DICOM Plan 142 or the Supplemental Plan 143. An area of concern in this example (marked in red) is that none of the Immobilization Devices 148 were entered. It would be necessary to enter the head and neck mask that was created for treating patient “Sherlock Holmes”. To do this, the user would click on a “New” button 149 in the Immobilization Devices section 148.

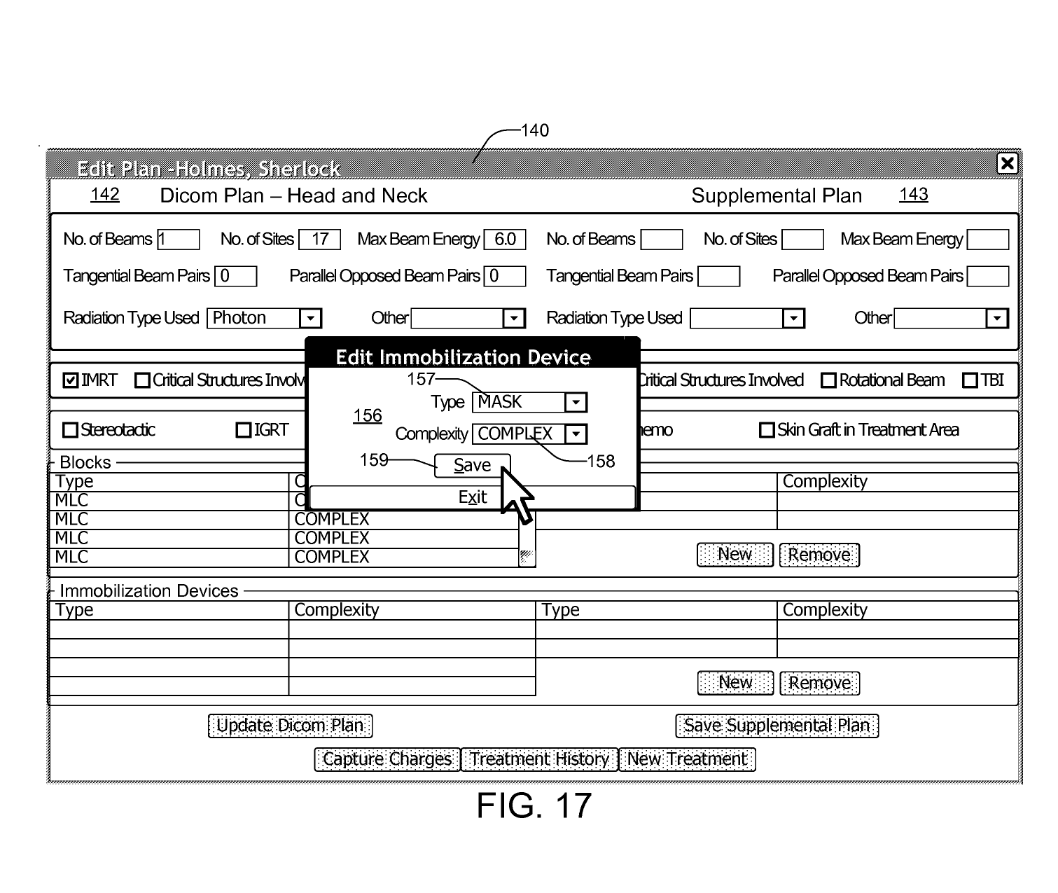

FIG. 17 is a drawing showing an Edit Immobilization Device pop-up window 156 overlaid over the inactive Edit Plan window 140 shown in FIGS. 14-16 for exemplary patient “Sherlock Holmes”. This window is launched when the user clicks on the “New” Immobilization Devices button 149. Most planning software does not record immobilization devices, however the DICOM standard allows these fixation devices to be specified in the RT PATIENT SETUP MODULE. In the future, planning systems should allow for this data to be automatically entered. Until then, these devices will have to be entered manually or image recognition software could be used. In this FIG., the type of immobilization device is specified 157, as well as the complexity of the device 158. A user completes the selections by clicking on a “Save” button 159.

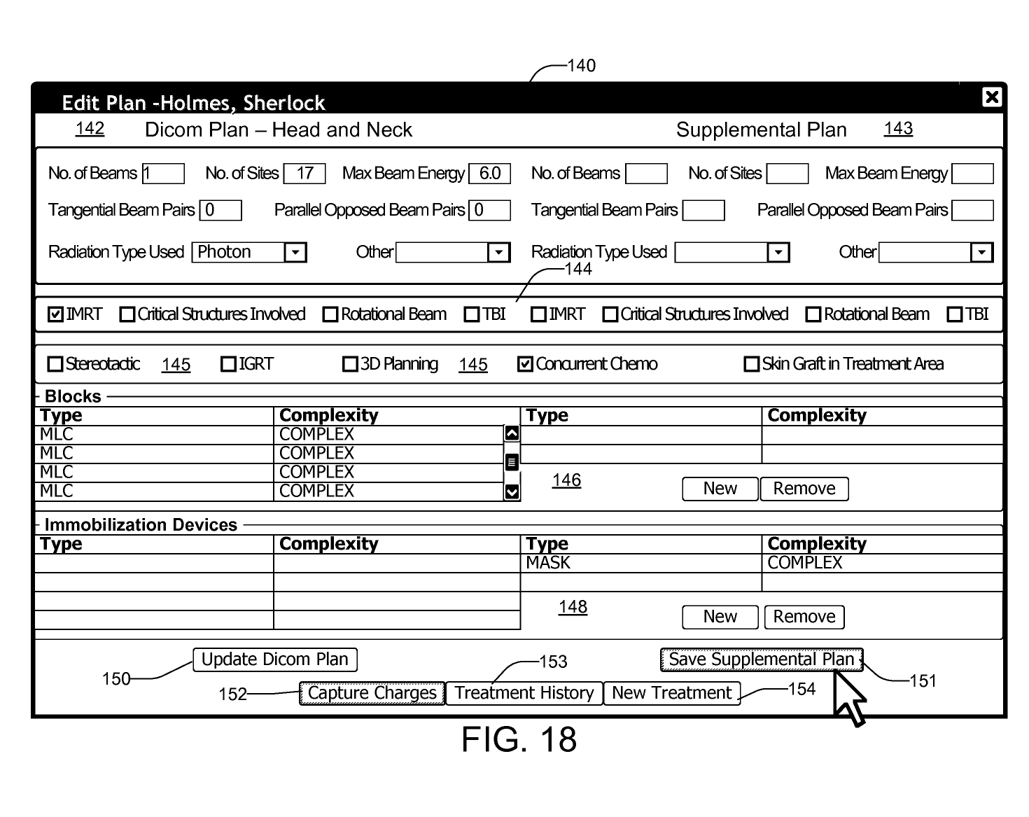

FIG. 18 is a drawing showing the Edit Plan window 140 shown in FIG. 16, after the immobilization device was selected in FIG. 17. The window 140 shows the newly added immobilization device 148 under the Supplemental Plan 143. This change can then be saved by clicking on the “Save Supplemental Plan” button 151.

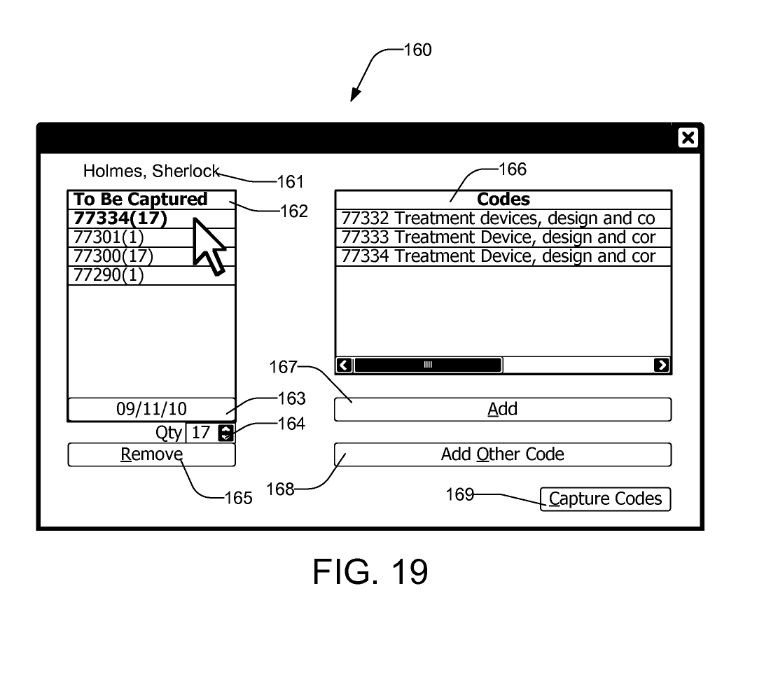

FIG. 19 is a drawing showing a billing Code Capture window 160, in accordance with one embodiment of the present invention and the example given in FIGS. 12-18 of exemplary patient “Sherlock Holmes”. Now that the plan is complete and assigned to the proper treatment course, the planning codes can be captured. The plan is computed against a billing scoring algorithm and proper billing codes are presented to the user for review.

The software is recommending seventeen (17) complex treatment devices be billed with a code of 77334. This is for sixteen (16) complex blocks derived from the MLC and the mask immobilization device. It also recommends a 77301 IMRT planning code be billed because this is an IMRT head and neck plan. Additionally, seventeen (17) 77300 basic dosimetry radiation calculation charges are recommended, one for each of the 17 beam sequences. Finally, a 77290 complex simulation code is suggested. These recommendations are comprehensive and accurate. However, the user can edit the quantity or dates of each code.

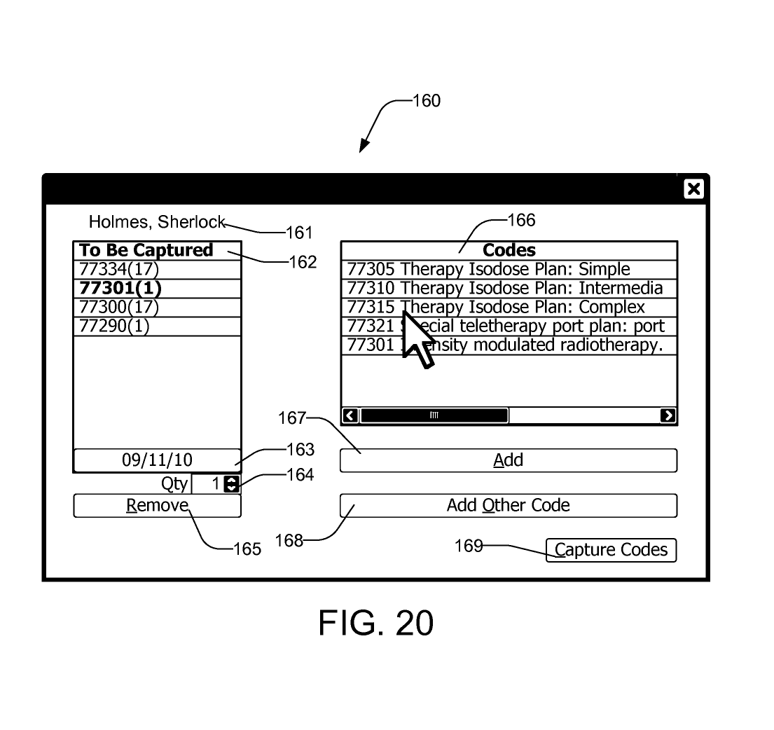

FIG. 20 is a drawing showing the billing Code Capture window 160 shown in FIG. 19 with a different set of codes highlighted and displayed. By clicking on each code the user is presented with a list of alternative codes from the same category that can be billed. The user can selectively remove codes. On the top of the window is displayed the name of the patient 161, in this case, “Holmes, Sherlock”. Below that on the left is a control box listing the codes already designated to be captured 162. Next to each code is the quantity in parenthesis. Currently displayed are: 77334(17); 77301(1); 77300(17); and 77290(1), as described above. Below those codes and quantities is the date of the treatment 163, as well as a spin control for determining or adjusting the quantity of the selected code 164. Below the Quantity control 164 is a “Remove” button 165 for removing the selected and highlighted code. On the right side of the window is a list of potential codes 166. The user can select one of the codes in this box and add that code to the list of codes to be captured on the left by clicking on an “Add” button 166. Alternatively, the user can add other codes by clicking an “Add Other Code” button 167. The codes are then captured by a user clicking a “Capture Codes” button 169 on the bottom of the window.

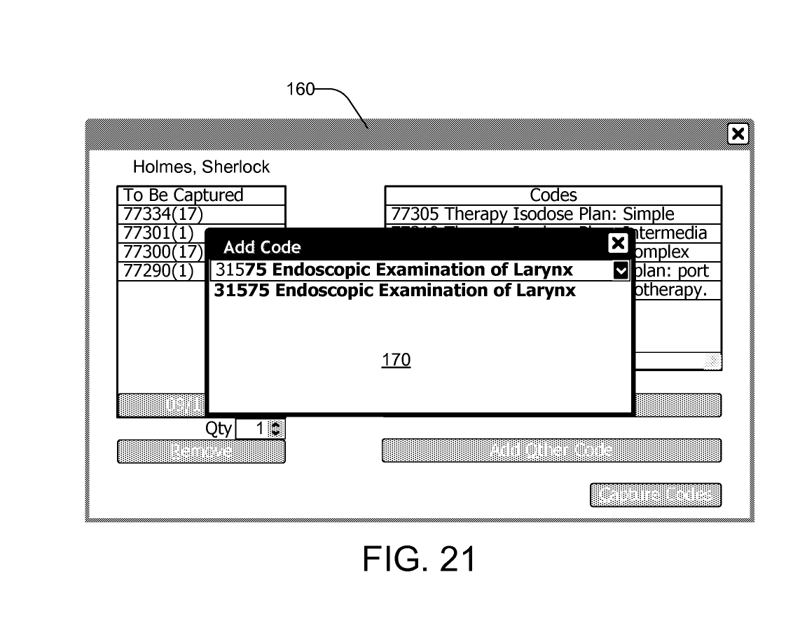

FIG. 21 is a drawing showing an Add Code window 170 above an inactive billing Code Capture window 160 shown in FIG. 20. The user can bill a completely different code if he/she chooses. This window is displayed when the user clicks the “Add Other Code” button 168. In this case, the user has keyed in “315” and the software system has suggested on a pull-down menu “31575 Endoscopic Examination of Larynx”. If the user clicks on this selection, it will be added to the codes to be captured.

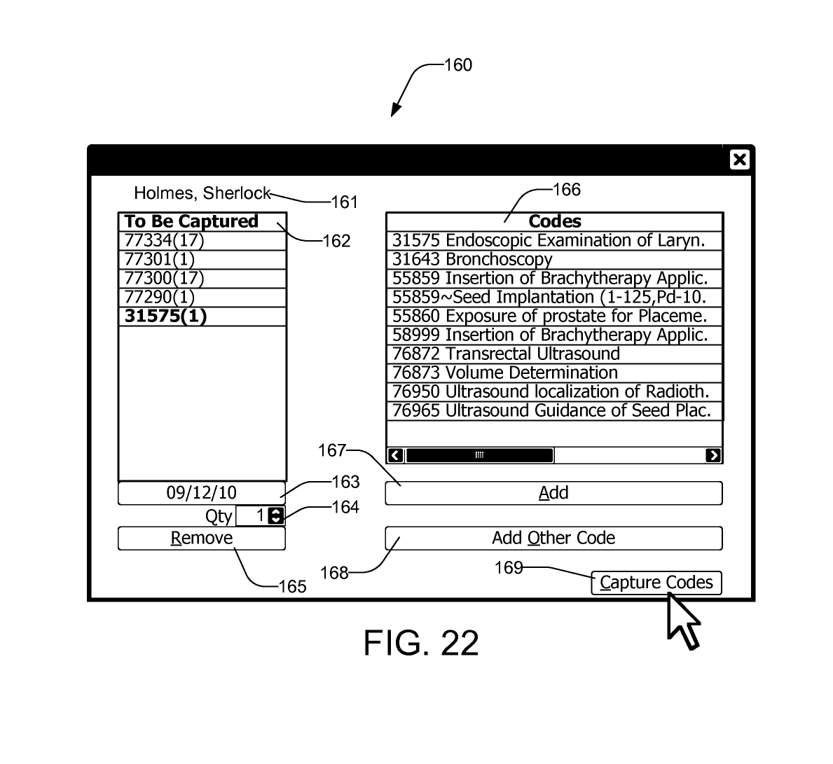

FIG. 22 is a drawing showing the billing Code Capture window 160 shown in FIGS. 19 and 20 after the code from the Add Code menu 170 shown in FIG. 21 has been accepted. The 31575 code is now shown at the bottom of the “To Be Captured” box 162 with a default quantity of one (1). When the user is done reviewing, the codes can be captured. This is accomplished by clicking a “Capture Codes” button 169 on the bottom of the window.

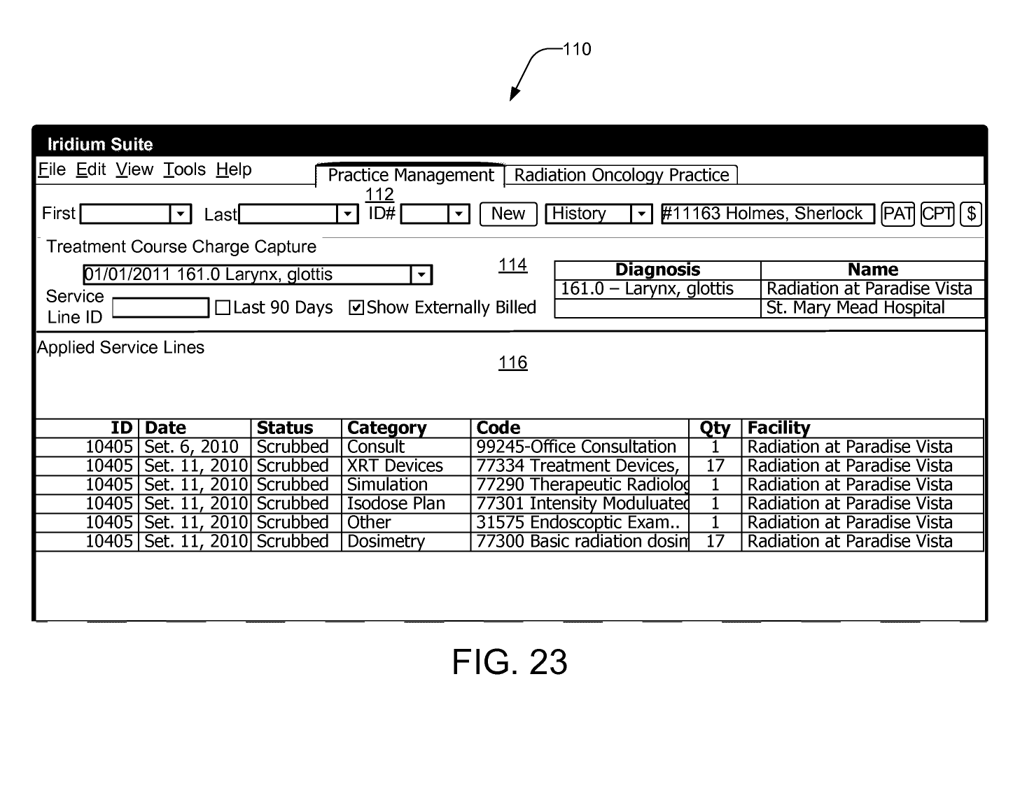

FIG. 23 is a drawing showing a Practice Management window 110, in accordance with the embodiment and example shown in FIG. 7, showing the codes from FIG. 22 captured. The five codes from FIG. 22 have been added, along with their respective quantities (Qty), dated Sep. 11, 2010, to the single code previously shown in FIG. 7, dated Sep. 6, 2010, in the Applied Service Lines section 116 of the window. The codes have now been added to the account of exemplary patient Sherlock Holmes.

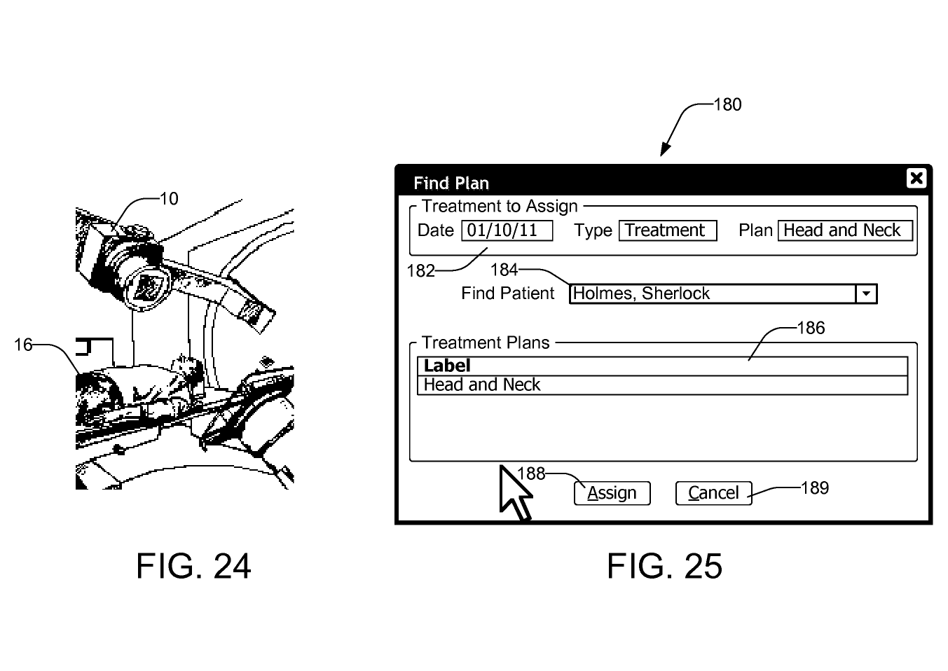

FIG. 24 is a drawing showing an example of treatment apparatus 10 being used to apply treatment to a patient 16. Now that simulation is completed, treatment will start. For every fraction delivered, charges may be billed. When the treatment is delivered, the computer system 12 controlling the treatment apparatus 10, such, as a linear accelerator, can relay the treatment data along with the patient identifiers to the software system 86 over the network 80 utilizing the DICOM RT protocol.

FIG. 25 is a drawing showing a Find Plan popup window 180, in accordance with the embodiment and example shown in FIGS. 5-23 above. When the treatment is received, the system will automatically popup the capture window allowing the user to immediately process and bill the charge. The first time the treatment is billed it will have the user find and verify the correct treatment plan that the treatment is tied to. The system found Sherlock Holmes' plan. It can be selected and assigned to the patient by clicking on an “Assign” button. However if the proper treatment plan can't be found it can be queued like the plan file to be processed at a later date. In this case, the user would click a “Cancel” button. The Find Plan window 180 shows information about the Treatment to Assign 182 at the top of the window. It includes date of treatment, type of treatment, and plan name. This is followed by a pull down Find Patient menu 184 for the Patient that defaults to the patient selected automatically. However, this can be changed by use of that pull-down menu 186. Then, below the Find Patient box 184 is a listing of the Treatment Plans 186. In this example, a treatment plan titled “Head and Neck” is listed. “Assign” 188 and “Cancel” 189 buttons are located on the bottom of the window.

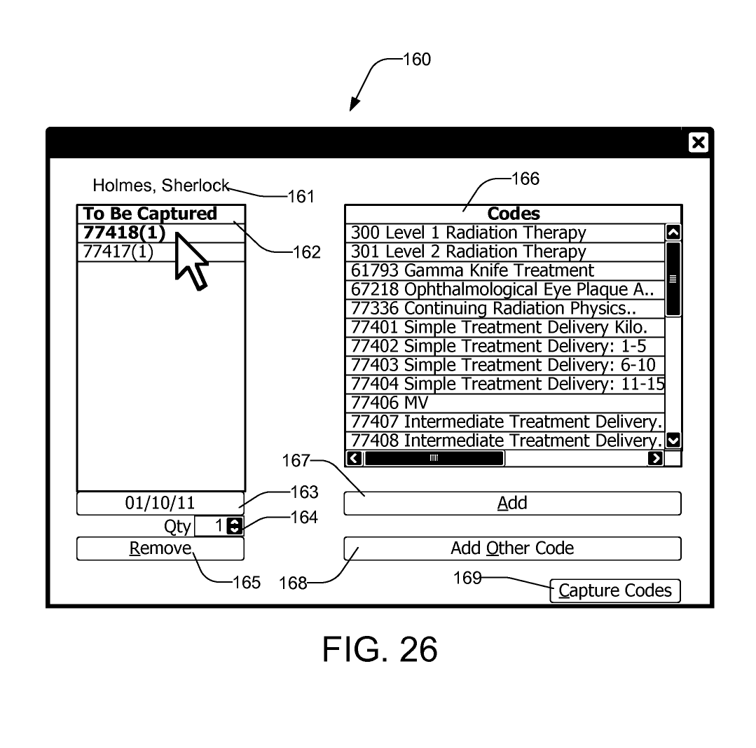

FIG. 26 is a drawing showing an Add Code window 160, in accordance with the embodiment and example shown in FIGS. 6-25. When the correct plan is selected the treatment will be processed and appropriate charges will be recommended based on a combination of the planning data and the treatment delivery data. In this example, a 77418 IMRT treatment delivery charge is highlighted as recommended and is appropriate for the type of radiation delivered. It is also recommending that a 77417 code be billed because a port film was taken. These charges can now be billed.

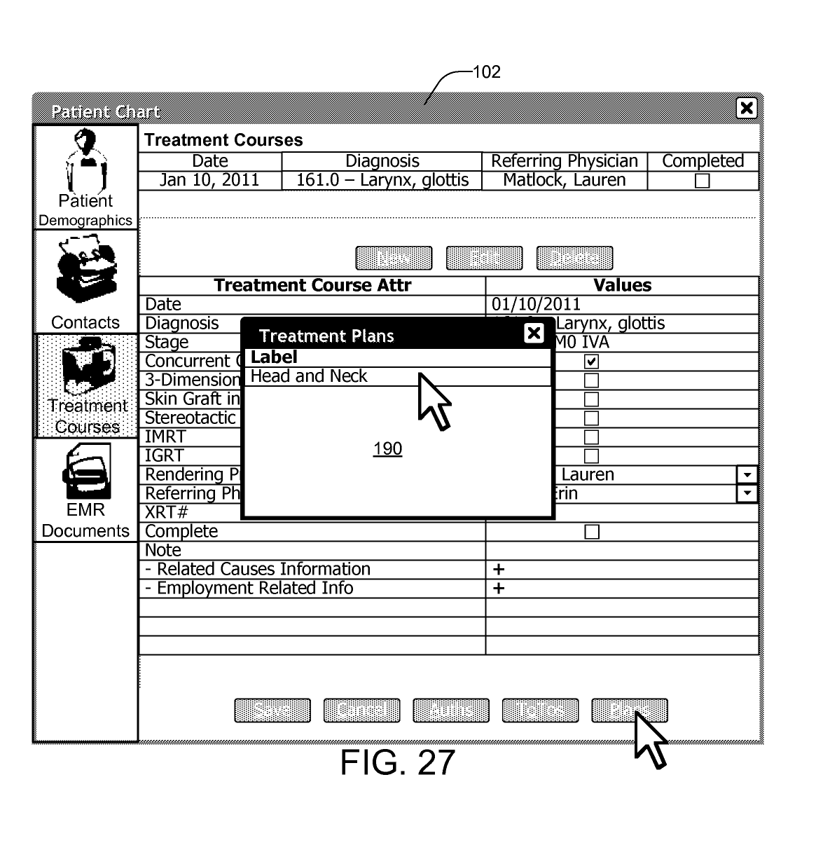

FIG. 27 is a drawing showing an inactive Treatment Courses window 190 overlaid over an inactive Treatment Plan window 102, in accordance with the embodiment and example shown in FIG. 6. The user can at any time review the treatment plans associated with their account. Sherlock Holmes' head and neck plan is shown in this FIG.

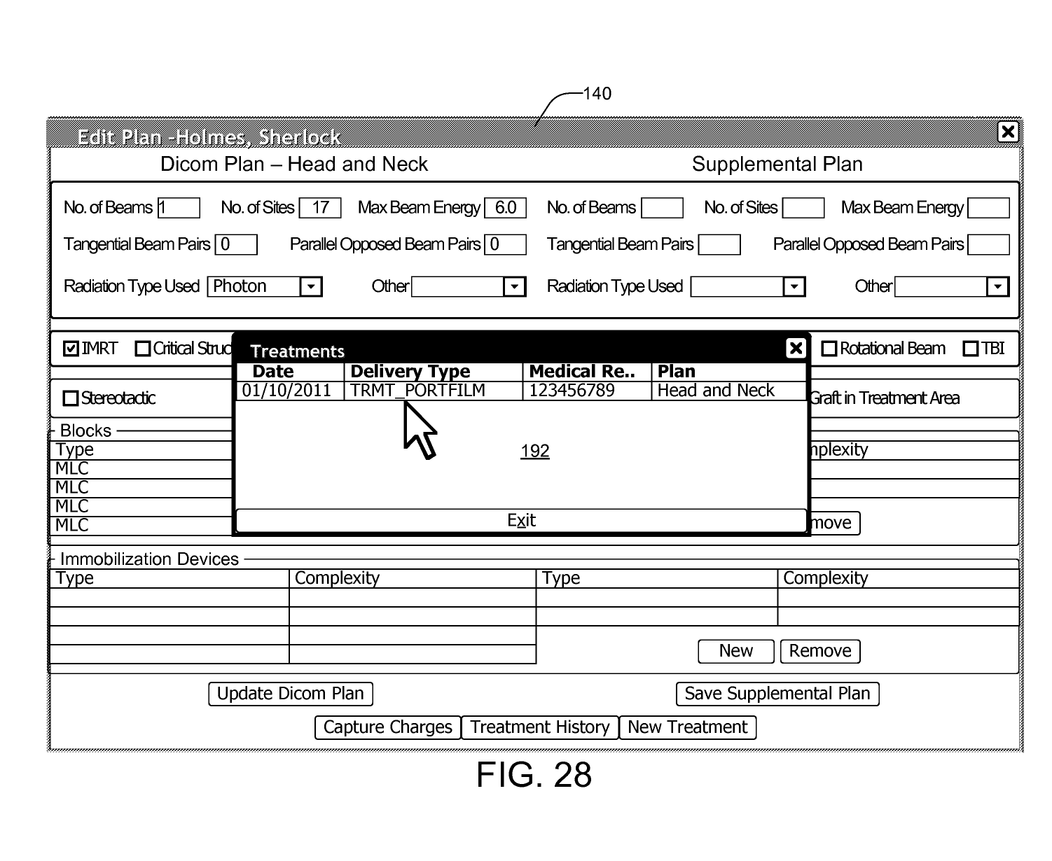

FIG. 28 is a drawing showing an active Treatments window 192 overlaid over an inactive Edit Plan window 140, as shown in FIGS. 14-18. The Treatments window 192 shows the Port Film treatment discussed with FIG. 26 above.

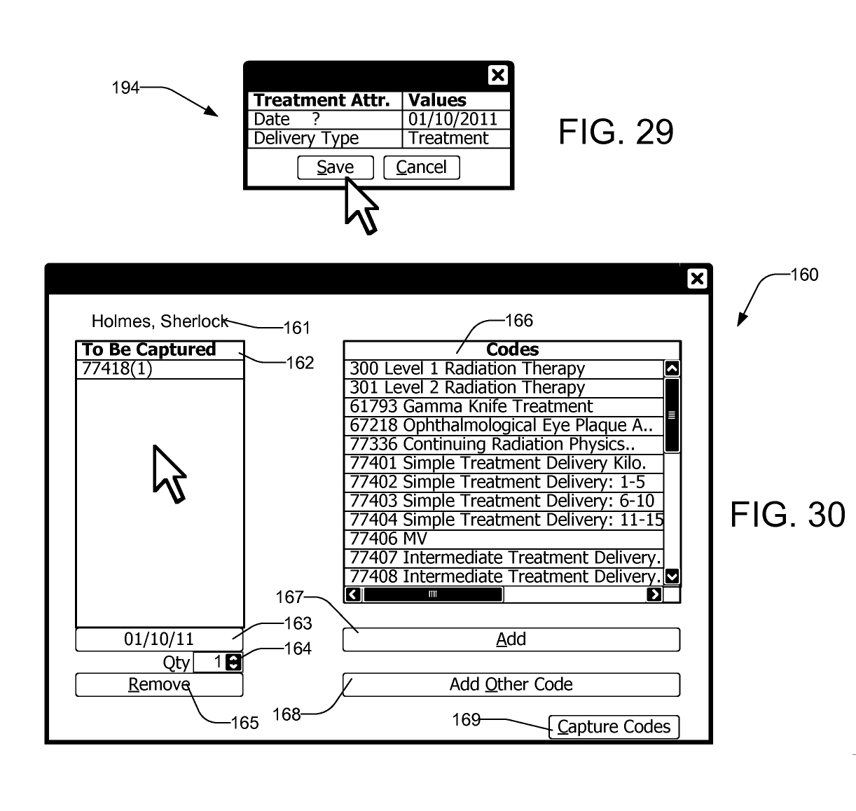

FIG. 29 is a drawing showing a Treatment Attribute window 194, in accordance with the embodiment and example show in FIGS. 6-28 above. FIG. 30 shows a Capture Code window 160, in accordance with the embodiment and example shown in FIGS. 6-28 above. The user can manually bill outside the workflow if necessary. For example, the user can also manually enter a treatment for billing if one was missed for some reason.

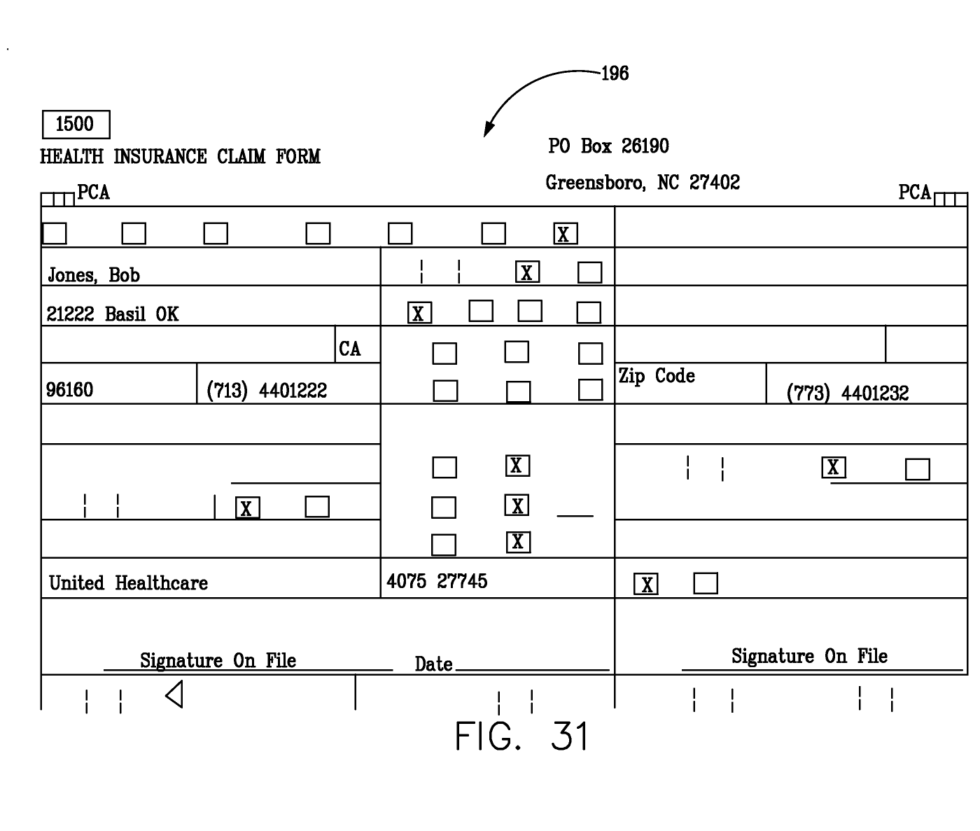

FIG. 31 is a drawing showing an exemplary Health Insurance Claim Form 196, in accordance with one embodiment of the present invention. The charges can then be billed to the payer. In an institutional environment the charges can be exported for processing by the external billing system. In a free standing clinic the charges can be batched electronically or paper HCFAs can be generated.

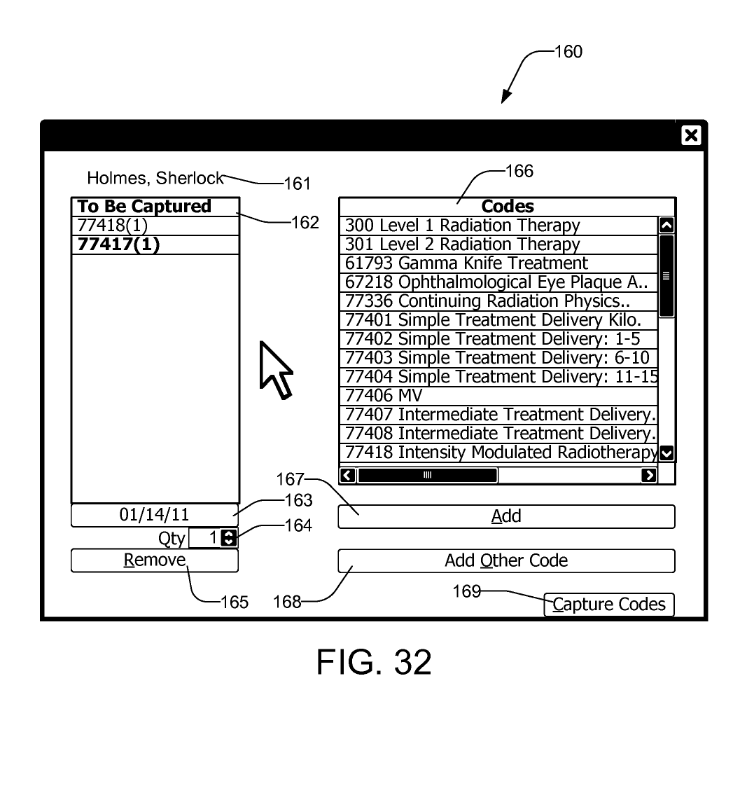

FIG. 32 is a drawing showing a Code Capture window, in accordance with the embodiment and example shown in FIGS. 5-31 above. As treatment continues on each patient, for each treatment, the user will simply be presented with this auto displayed Treatment Capture window. The user has only to review the recommendations and finalize the automated charge capture. If the patient is receiving 30 treatments then this is the only step required for the last 29 treatments.

As can be seen, this system follows a very natural workflow. It reduces redundancy and increases billing accuracy by using the original planning data that was entered by the dosimetrist themselves. This system is based on data and resources already available in standard radiation oncology practice. Radiation Therapy billing is complicated, but radiation therapy planning and treatment is much more complicated. There is no need for the physicians, techs and physicists to be burdened with performing unnecessary steps when they already entered the planning data correctly. Ultimately the automation of the charge capture process will improve worker productivity and result in lower costs to the clinic.

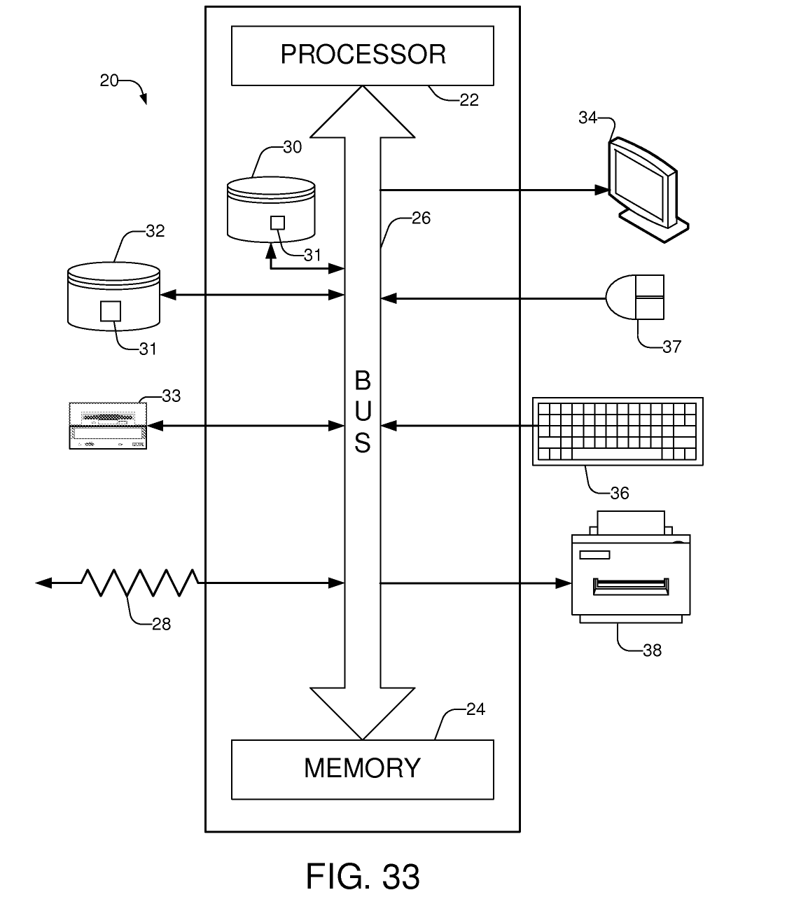

FIG. 33 is a block diagram illustrating a General Purpose Computer 20, such as are shown as computers and servers 12, 82, 84, 88 in FIG. 4. The General Purpose Computer 20 may have a Computer Processor 22, and Memory 24, connected by a Bus 26. Memory 24 may be a relatively high speed machine readable medium and includes Volatile Memories such as DRAM, and SRAM, and Non-Volatile Memories such as, ROM, FLASH, EPROM, EEPROM, and bubble memory. Also coupled to the Bus may be communications links 28, Secondary Storage 30, External Storage 32, Removable Storage 33, output devices such as a monitor 34, input devices such as a keyboard 36 with a mouse 37, and printers 38. Communications links 28 may be wired, such as RS-232, Ethernet, USB, or FireWire®, or wireless, such as WiFi, Bluetooth®, and IR. Secondary Storage 30 includes machine-readable media such as hard disk drives, magnetic drum, and bubble memory. External Storage 32 includes external disk drives and even other computers, possibly connected via a communications link 28. Removable Storage 33 includes machine-readable media such as floppy disks, removable hard drives, magnetic tape, CDs, DVDs, USB FLASH drives, etc. The distinction drawn here between Secondary Storage 30, External Storage 32, and Removable Storage 33 is primarily for convenience in describing the invention. As such, it should be appreciated that there is substantial functional overlap between these elements. Computer software 31 such test programs, operating systems, and user programs can be stored in a Computer Software Storage Medium, such as memory 24, Secondary Storage 30, External Storage 32, and Removable Storage 33. Executable versions of computer software 31, such as implementing the Radiation Therapy Billing system disclosed herein, can be read from a Non-Volatile Storage Medium such as Secondary Storage 30, External Storage 32, Removable Storage 33, and Non-Volatile Memory and loaded for execution directly into Volatile Memory, executed directly out of Non-Volatile Memory, or stored on the Secondary Storage 30 prior to loading into Volatile Memory for execution. It should be understood that this configuration and these components are exemplary, and other configurations and components are also within the scope of the present invention.

Those skilled in the art will recognize that modifications and variations can be made without departing from the spirit of the invention. Therefore, it is intended that this invention encompass all such variations and modifications as fall within the scope of the appended claims.

1. A method for billing a set of treatments utilizing a computer system, the method comprising:
executing instructions stored on a non-transitory computer-readable storage medium, wherein the execution of the instructions by a computer processor:
receives treatment plan data regarding radiation therapy from a user;
matches the treatment plan data with a corresponding patient;
analyzes the treatment plan data to identify a billable component;
assigns a score to the billable component; and
generates a billing code for the treatment plan data based on the score.

2. The method of claim 1, further comprising executing instructions stored on a non-transitory computer-readable storage medium, wherein the execution of the instructions by a computer processor transmits the billing code to a billing system.

3. (canceled)

4. The method of claim 1, further comprising executing instructions stored on a non-transitory computer-readable storage medium, wherein the execution of the instructions by a computer processor:
presents the treatment plan data to the user;
receives supplemental treatment plan data from the user;
analyzes the supplemental treatment plan data to identify a billable component;
assigns a score to the billable component; and
generates a billing code for the supplemental treatment plan data.

5. (canceled)

6. (canceled)

7. The method of claim 1, wherein the execution of the instructions by a computer process receives the treatment plan data in a Digital Imaging and Communications in Medicine (DICOM) format.

8. The method of claim 7, wherein the execution of the instructions by a computer processor receives treatment plan data that identifies a plurality of beams and other modalities to be applied, when and where the beams and other modalities are to be applied, and at what angles and intensities the beams and other modalities are to be applied.

9. (canceled)

10. The method of claim 1, further comprising executing the instructions stored on the non-transitory computer-readable storage medium to simulate a treatment using the treatment plan data.

11. A system for billing a set of treatments, the system comprising:
an instruction-executing computer processor; and
a code interpreter stored in a non-transitory computer-readable storage medium, the code interpreter being executable by the processor to:
receive treatment plan data regarding radiation therapy from a user,
match the treatment plan data with a corresponding patient,
analyze the treatment plan data to identify a billable component,
assign a score to the billable component, and
generate a billing code for the treatment plan data based on the score.

12. The system of claim 11, wherein the code interpreter stored in the non-transitory computer-readable storage medium is further executable by the processor to transmit the billing code to a billing system.

13. (canceled)

14. The system of claim 11, wherein the code interpreter stored in the non-transitory computer-readable storage medium is further executable by the processor to:
present the treatment plan data to the user,
receive supplemental treatment plan data from the user,
analyze the supplemental treatment plan data to identify a billable component,
assign a score to the billable component, and
generate a billing code for the supplemental treatment plan data.

15. (canceled)

16. (canceled)

17. The system of claim 11, wherein the code interpreter stored in the non-transitory computer-readable storage medium is further executable by the processor to receive the treatment plan data in a Digital Imaging and Communications in Medicine (DICOM) format.

18. The system of claim 17, wherein the code interpreter stored in the non-transitory computer-readable storage medium is further executable by the processor to analyze the treatment plan data to identify a plurality of beams and other modalities to be applied, when and where the beams and other modalities are to be applied, and at what angles and intensities the beams and other modalities are to be applied.

19. (canceled)

20. The system of claim 11, wherein the code interpreter stored in the non-transitory computer-readable storage medium is further executable by the processor to simulate a treatment using the treatment plan data.

21. A non-transitory computer-readable storage medium having embodied thereon a set of computer executable instructions for billing a set of treatments utilizing a computer system, the set of computer executable instructions executable to:
receive treatment plan data regarding radiation therapy from a user;
match the treatment plan data with a corresponding patient;
analyze the treatment plan data to identify a billable component;
assign a score to the billable component; and
generate a billing code for the treatment plan data based on the score.
